(19) United States
(12) Patent Application Publication
(10) Pub. No.: US 2023/0401841 A1
(43) Pub. Date: Dec. 14, 2023

(54) ABNORMALITY DETERMINATION APPARATUS, ABNORMALITY DETERMINATION SYSTEM, ABNORMALITY DETERMINATION METHOD AND NON-TRANSITORY COMPUTER-READABLE RECORDING MEDIUM STORING ABNORMALITY DETERMINATION PROGRAM

(71) Applicant: Mitsubishi Electric Corporation, Tokyo (JP)

(72) Inventors: Kentaro ISHIKAWA, Tokyo (JP); Noritaka KOKIDO, Tokyo (JP); Hiroki FUJIYOSHI, Tokyo (JP)

(73) Assignee: Mitsubishi Electric Corporation, Tokyo (JP)

(21) Appl. No.: 18/144,494

(22) Filed: May 8, 2023

(30) Foreign Application Priority Data
Jun. 10, 2022 (JP) 2022-094058

(51) Int. Cl. G06V 10/98; G06V 20/58; G06T 7/73

(52) U.S. Cl. CPC G06V 10/98; G06V 20/58; G06T 7/74

(57) ABSTRACT

An abnormality determination apparatus is provided which can determine the presence or absence of abnormality by defining known information as reference information, and by comparing the reference information with information from a sensor(s). The abnormality determination apparatus comprises: an object-matter detection unit for performing object-matter detection on the basis of a reception signal outputted from an onboard surroundings monitoring sensor being included in an object-matter detecting sensor(s); an absolute location calculation unit for transforming a relative location of an object-matter contained in an object-matter detection result outputted from the object-matter detection unit into an absolute location; and an abnormality determination unit for performing determination whether or not abnormality is caused in the onboard surroundings monitoring sensor by comparing absolute location information outputted from the absolute location calculation unit with reference information.

### BACKGROUND OF THE INVENTION

### Field of the Invention

The disclosure of the present application relates to an abnormality determination apparatus, an abnormality determination system, an abnormality determination method and a non-transitory computer-readable recording medium storing an abnormality determination program.

### Description of the Related Art

A technology and a system each for performing an automated driving to avoid a collision with an obstacle in an area where a roadside unit (also referred to as an infrastructure sensor, Road Side Unit, RSU, or the like) is placed are proposed which are based on obstacle information detected by using a sensor(s) mounted on an automotive or motor vehicle and on host-vehicle's location information acquired from information of a global positioning system, GPS, mounted on the motor vehicle and/or that of a geographic map, and based in addition to those pieces information on obstacle information detected by using a sensor(s) mounted on the roadside unit and/or information of a GPS or information of a geographic map.

Here, it is no more possible for the aforementioned system to operate normally when abnormality is caused in any one of a sensor(s) mounted on a motor vehicle (hereinafter, an “onboard sensor”), a GPS mounted on a motor vehicle (hereinafter, an “onboard GPS”) and/or a sensor(s) mounted on a roadside unit (hereinafter, a “roadside sensor”). At a time of abnormality being caused, it is required to take countermeasures in such a manner that, in accordance with a position where the abnormality is caused and/or with the degree of the abnormality, the system is stopped in emergency, and/or that a message is displayed to take action for maintenance. Note that, “abnormality” designates not only a state in which a sensor fails, but also a state in which contaminants and/or a cover or the like are adhered on the sensor so that its capability is degraded, or a state in which a placement axis of the sensor is misaligned; and namely, the “abnormality” designates a state other than the normal state.

In Patent Document 1, a technology is described in which determination is performed whether or not an onboard sensor or a roadside sensor is abnormal by comparing obstacle information being detected using a roadside sensor with obstacle information being detected using an onboard sensor. In addition to that, another technology is also described in which, by selecting a plurality of number of motor vehicles and by using obstacle information being detected by each sensor for the comparison, determination is performed on a sensor in which sensor abnormality is caused.

[Patent Document 1] Japanese Patent Application Publication No. 2021-71908

According to technologies described in Patent Document 1, there arises a problem in that a plurality of number of motor vehicles is required for determining in which roadside unit and/or motor vehicle abnormality is caused. In addition, because abnormality determination is not performed with respect to a motor vehicle not being selected, there exists a possibility of delaying the abnormality determination even when abnormality is caused on the motor vehicle.

### SUMMARY OF THE INVENTION

The present invention of the application concerned has been directed at solving those problems as described above, and an object of the disclosure is to provide an abnormality determination apparatus in which, by defining known information as reference information, the presence or absence of abnormality is can be determined by comparing the reference information with information from a sensor(s).

In an abnormality determination apparatus disclosed in the present disclosure of the application concerned, the abnormality determination apparatus comprises: an object-matter detection unit for performing object-matter detection on the basis of a reception signal outputted from an object-matter detecting sensor; an absolute location calculation unit for transforming a relative location of an object-matter contained in an object-matter detection result outputted from the object-matter detection unit into an absolute location; and an abnormality determination unit for performing determination whether or not abnormality is caused in the object-matter detecting sensor by comparing absolute location information outputted from the absolute location calculation unit with reference information.

According to the abnormality determination apparatus disclosed in the disclosure of the application concerned, it is possible to determine the presence or absence of abnormality with respect to each of a roadside unit(s) and a motor vehicle(s), without using a plurality of number of motor vehicles.

### BRIEF DESCRIPTION OF DRAWINGS

FIG. 1 is a diagram for explaining a situation in an abnormality determination system according to Embodiment 1;

FIG. 2 is a hardware configuration diagram of the abnormality determination system according to Embodiment 1;

FIG. 3 is a functional block diagram of the abnormality determination system according to Embodiment 1;

FIG. 4 is a flowchart illustrating the operations of an abnormality determination apparatus in the abnormality determination system according to Embodiment 1;

FIG. 5 is a diagram for explaining a situation in an abnormality determination system according to Embodiment 2;

FIG. 6 is a functional block diagram of the abnormality determination system according to Embodiment 2;

FIG. 7 is a flowchart illustrating the operations of an abnormality determination apparatus in the abnormality determination system according to Embodiment 2;

FIG. 8 is a diagram for explaining a situation in an abnormality determination system according to Embodiment 3;

FIG. 9 is a functional block diagram of the abnormality determination system according to Embodiment 3;

FIG. 10 is a flowchart illustrating the operations of an abnormality determination apparatus in the abnormality determination system according to Embodiment 3;

FIG. 11 is a diagram for explaining a situation in an abnormality determination system according to Embodiment 4;

FIG. 12 is a hardware configuration diagram of the abnormality determination system according to Embodiment 4;

FIG. 13 is a functional block diagram of the abnormality determination system according to Embodiment 4;

FIG. 14 is a flowchart illustrating the operations of an abnormality determination apparatus in the abnormality determination system according to Embodiment 4; and

FIG. 15 is a flowchart illustrating the operations of abnormality determination processing of a motor vehicle in the abnormality determination system according to Embodiment 4.

### DETAILED DESCRIPTION OF THE PREFERRED EMBODIMENTS

### Embodiment 1

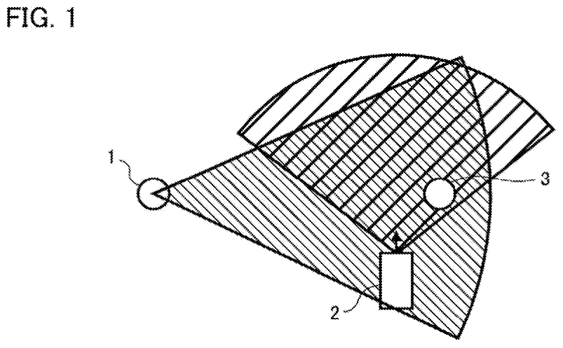

Hereinafter, the explanation will be made referring to FIG. 1 through FIG. 4 for Embodiment 1. Note that, the same contents and/or corresponding items, portions or parts designate the same reference numerals and symbols, and thus, their detailed explanation will be omitted.

<Explanation of Configurations>

FIG. 1 shows an implementation example of an abnormality determination system according to the embodiment.

The abnormality determination system is constituted of a roadside unit 1, an automotive or motor vehicle 2 and a target object 3 (referred to as a “TOBJ3,” for brevity in part of figures), and a server not shown in FIG. 1 (the explanation will be made later in detail).

By using the target object 3, determination is consecutively performed whether or not abnormality is caused in the roadside unit 1 and the motor vehicle 2, and an abnormality determination result(s) is consecutively transmitted to the server, so that the server notifies the determination result(s). Hereinafter, the explanation will be made in detail for each of constituent elements.

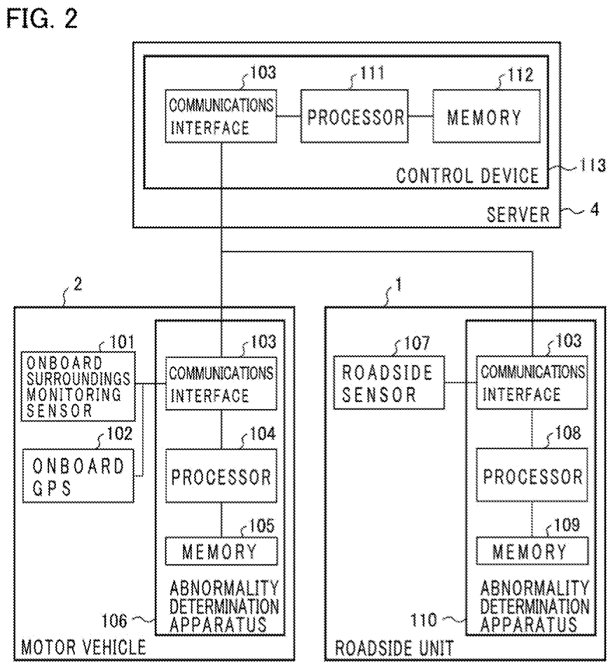

The roadside unit 1 is placed in the surroundings of a road(s) in an area in which automated driving is performed, and the roadside unit includes a role to detect an object-matter on the road(s) and in the surroundings of the road(s). For example, as illustrated in FIG. 2 which will be described later, the roadside unit 1 comprises an object-matter detecting sensor (hereinafter, referred to as a roadside sensor 107) such as an image recognition camera, a millimeter-wave radar, a light detection and ranging (LiDAR) sensor and/or the like, and comprises a communications mechanism with respect to the server, so that the roadside unit 1 detects an object-matter (s) such as a motor vehicle(s), a pedestrian(s) and/or the like by the roadside sensor 107.

Note that, the kinds of a sensor(s) and/or an object-matter(s) as a detection subject-matter are not limited to those; however, it is required for such a sensor(s) to be configured capable of detecting the aforementioned target object 3. While on the other hand, as the target object 3, it is required to use an object-matter which can be detected by the roadside sensor 107. For example, it is such a case that the roadside sensor 107 is provided with a millimeter-wave radar, and the target object 3 is a reflector in use for the millimeter-wave radar. The combination of the roadside sensor 107 and the target object 3 is not limited this.

Moreover, the roadside unit 1 also consecutively performs abnormality determination of the roadside unit on its own, and consecutively transmits the determination result to the server as will be described later.

The motor vehicle 2 is an automotive vehicle which runs in an area where the roadside unit 1 is placed, and is provided with: an object-matter detecting sensor (hereinafter, referred to as an onboard surroundings monitoring sensor 101) such as an image recognition camera, a millimeter-wave radar, a LiDAR sensor, an ultrasonic sensor (sonar) and/or the like on the exterior surface (including the reverse side or the like of a bumper) of the motor vehicle 2; a GPS (hereinafter, referred to as an onboard GPS 102); and a communications mechanism with respect to the server. By using these, an object-matter(s) in the surroundings of the motor vehicle 2 is detected by the onboard surroundings monitoring sensor 101, and a relative location of an object-matter having been detected is transformed into that in an absolute coordinate system by means of the onboard GPS 102, so that, for example, the absolute coordinates are displayed on a geographic map of an onboard display (not shown in the figures). And then, an automated driving control and/or driving assistance are carried out by utilizing these results.

Moreover, the motor vehicle 2 also consecutively performs abnormality determination of the motor vehicle on its own, and consecutively transmits the determination result(s) to the server which is not shown in the figure.

Note that, the motor vehicle 2 is an automotive vehicle of its own, for example; however, the motor vehicle 2 is not limited to that. And so, the motor vehicle 2 may be another four-wheeled automotive vehicle such as a truck and/or a golf cart; or the motor vehicle 2 may also be another mobile object such as a motorcycle or a personal mobility vehicle (Personal Mobility Vehicle, PMV), and/or an autonomous mobile robot (Autonomous Mobile Robot, AMR), and so forth.

Moreover, the target object 3 is placed at a location whose placement coordinates are made clear, and is provided to have a shape and/or characteristics which can be detected by the roadside sensor 107 and the onboard surroundings monitoring sensor 101. While on the other hand, the roadside sensor 107 and the onboard surroundings monitoring sensor 101 are configured so that they can detect the target object 3. For example, it is possible to take on a configuration similar to that described above so that a reflector in use for a millimeter-wave radar is used as the target object 3, and that millimeter-wave radars are provided with the roadside sensor 107 and the onboard surroundings monitoring sensor 101.

In addition, a server (not shown in FIG. 1) notifies an abnormality determination result(s) transmitted from the roadside unit 1 and/or the motor vehicle 2. The notification contents can be displayed on a display, for example, on the server side for each determination result itself, for example. The notification method and/or the contents are not limited to those, so that it is possible to adopt a method in which, for example, the determination result(s) is transmitted to the motor vehicle 2, and then conveyed in a voice to a driver of the motor vehicle 2 and/or to a passenger(s) thereof; and, on a display thereof, it is also possible to display the determination result(s). While on the other hand, when abnormality is determined so that it exists in the roadside unit 1, it may be so arranged that, by making contact with the operator, he or she is instructed toward a placement location of the roadside unit 1 for its repair, maintenance and/or the like. Moreover, it may be so arranged that, in accordance with the determination result(s), a signal for use in the control(s) is transmitted to the roadside unit 1, and/or to the roadside unit 1 and the motor vehicle 2, so that the roadside unit 1 is controlled, and/or the roadside unit 1 and the motor vehicle 2 are controlled. For example, when determination is performed so that the motor vehicle 2 is abnormal, the motor vehicle 2 may be stopped in emergency by remotely controlling it from the server.

FIG. 2 is a diagram illustrating, by way of example, a hardware configuration of an abnormality determination system according to the embodiment. The abnormality determination system is constituted of the roadside unit 1, the motor vehicle 2 and a server 4 as illustrated in the figure.

The roadside unit 1 comprises the roadside sensor 107 described above, and an abnormality determination apparatus 110 as shown in FIG. 2. The abnormality determination apparatus 110 includes a general computer and/or an electronic control unit (Electronic Control Unit, ECU), and comprises a processor 108, a memory 109 and a communications interface 103. The communications interface is connected by means of a signal line(s) and/or radio communications to a communications interface inside of the server 4 as this will be described later.

The abnormality determination apparatus 110 performs determination on the presence or absence of abnormality of the roadside sensor 107 by using a signal received from the roadside sensor 107, and transmits the determination result(s) to a control device 113 inside of the server 4.

Note that, the abnormality determination apparatus 110 may be mounted inside of the roadside unit 1 in a form in which the abnormality determination apparatus is integrally made with its other constituent elements, or in a form in which the abnormality determination apparatus cannot be separated from them; or the abnormality determination apparatus 110 may also be mounted in a form in which the abnormality determination apparatus can be detached from them, or in a form in which the abnormality determination apparatus can be separated from them.

The motor vehicle 2 comprises the onboard surroundings monitoring sensor 101 and the onboard GPS 102 described above, and an abnormality determination apparatus 106 as shown in FIG. 2. The abnormality determination apparatus 106 includes a general computer and/or an electronic control unit (Electronic Control Unit, ECU), and comprises a processor 104, a memory 105 and a communications interface 103. The communications interface is connected by means of radio communications to a communications interface inside of the server 4 as this will be described later.

The abnormality determination apparatus 106 determines, by using signals received from the onboard surroundings monitoring sensor 101 and the onboard GPS 102, the presence or absence of abnormality in these onboard surroundings monitoring sensor and onboard GPS, and transmits determination results to the control device 113 inside of the server 4.

Note that, the abnormality determination apparatus 106 may be mounted inside of the motor vehicle 2 in a form in which the abnormality determination apparatus is integrally made with its other constituent elements, or in a form in which the abnormality determination apparatus cannot be separated from them; or the abnormality determination apparatus 106 may also be mounted in a form in which the abnormality determination apparatus can be detached from them, or in a form in which the abnormality determination apparatus can be separated from them.

The server 4 comprises the control device 113 as illustrated in FIG. 2. The control device 113 includes a general computer and/or an electronic control unit (Electronic Control Unit, ECU), and comprises a processor 111, a memory 112 and a communications interface 103. The communications interface is connected by means of a signal line(s) and/or radio communications to the roadside unit 1 and to a communications interface inside of the motor vehicle 2.

The control device 113 performs the notification on the basis of an abnormality determination result(s) transmitted from the roadside unit 1 and/or from the motor vehicle 2 according to various kinds of methods described above.

Note that, the control device 113 may be mounted inside of the server 4 in a form in which the control device is integrally made with its other constituent elements, or in a form in which the control device cannot be separated from them; or the control device 113 may also be mounted in a form in which the control device can be detached from them, or in a form in which the control device can be separated from them.

Note that, the processor 108, the processor 104 and the processor 111 described above are each processing devices for reading out a program(s) stored in the memory 109, the memory 105 and the memory 112, and for executing the program(s), respectively. The processing devices each may also be called as integrated circuits (Integrated Circuits, ICs). The processors are each central processing units (Central Processing Units, CPUs) as specific examples.

In addition, the memories 109, 105 and 112 is constituted of a main storage device (not shown in the figures) for storing primary or temporary data at the times of the processors 108, 104 and 111 execute a program(s), and an auxiliary storage device (not shown in the figures) for storing a program(s) where the processors execute, various kinds of parameters such as a threshold value(s) or the like, and the like.

In the main storage device, temporarily stored are: reception signals obtained from the roadside sensor 107, and/or the onboard surroundings monitoring sensor 101 and the onboard GPS 102; and abnormality determination results transmitted from the roadside unit 1 and the motor vehicle 2. The main storage device is constituted of a random access read-write memory (Random Access Memory, RAM) as a specific example.

The auxiliary storage device stores an abnormality determination program, an operating system (Operating System, OS) (not shown in the figures) and the like, and is constituted of a hard disk drive (Hard Disk Drive, HDD) and a random access read-only memory (Read-only Memory, ROM) as specific examples. The auxiliary storage device may be made of a transportable recording medium such as a NAND-type flash memory or the lime. A detection program(s) may be provided as a program product(s).

Moreover, the respective communications interface 103 functions to transmit to the processor 111 a signal of an abnormality determination result(s) or the like where the processor 108 or the processor 104 produces, and also functions to transmit to the processor 108 or to the processor 104 a signal of notification contents or the like where the processor 111 produces.

The communications interface 103 may be made of one interface which performs transmission/reception of a plurality of kinds of signals, or the communications interface 103 may also be made of a plurality of interfaces each having individual functions being required.

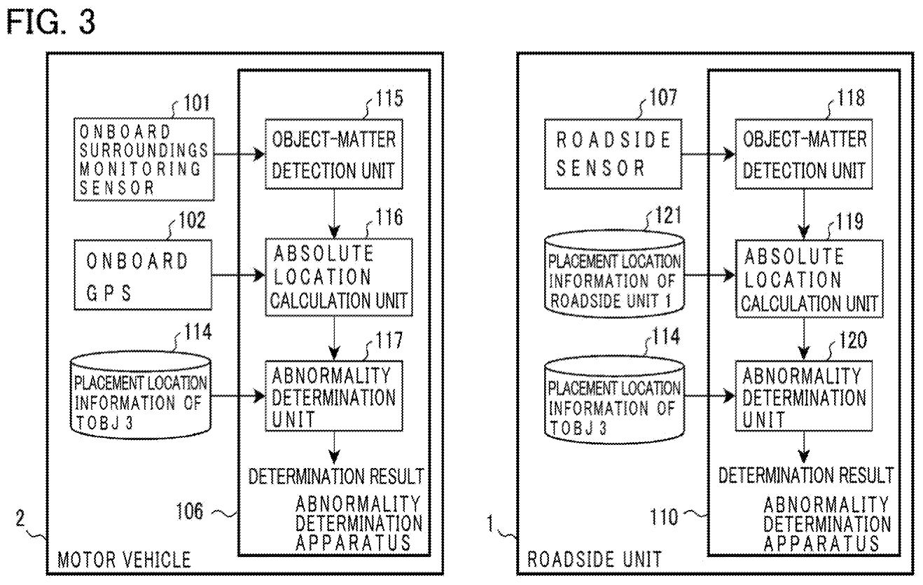

FIG. 3 is an example of a functional block diagram of the abnormality determination system. The explanation will be made referring to FIG. 3 for a configuration of the abnormality determination system.

The abnormality determination system is constituted of the roadside unit 1, the motor vehicle 2 and the server 4 as described above; however, because the server 4 only has therein the function for notifying an abnormality determination result (s), the server 4 is not shown in FIG. 3, and also its detailed explanation will be omitted. Note that, as described above, various methods in which a person having ordinary skill can take into consideration may be adopted as notification methods (in the notification, a remote control on the roadside unit 1 and/or that on the motor vehicle 2 are included).

First, the explanation will be made referring to FIG. 3 for the functions in which the roadside unit 1 includes. The abnormality determination apparatus 110 comprises an object-matter detection unit 118, an absolute location calculation unit 119 and an abnormality determination unit 120, and further, placement location information 121 of the roadside unit 1 and placement location information 114 of the target object 3 are stored in the memory 109 inside of the roadside unit 1.

The functions of each of the functional constituent elements of the object-matter detection unit 118, the absolute location calculation unit 119 and the abnormality determination unit 120 are implemented so that the processor 108 executes a program(s) for exerting the functions of each of the constituent portions or units.

The object-matter detection unit 118 receives a signal transmitted from the roadside sensor 107, and detects, by using the signal, an object-matter existing within a detection area of the roadside sensor 107. Here, various methods in which a person having ordinary skill can take into consideration may be adopted as methods of object-matter detection.

For example, it is possible to adopt a method in which the roadside sensor 107 is provided with an image recognition camera, so that a pickup image(s) by means of the camera is consecutively received, and, from the image(s) having been received, a location of an object-matter and/or a category thereof are detected by using a publicly known image recognition technology.

In addition, it is also possible to adopt a method in which, for example, the roadside sensor 107 is provided with a millimeter-wave radar, so that pieces of information such as the distance up to each of object-matters where the millimeter-wave radar outputs and/or a location, a speed or the like are consecutively received, and an object-matter is detected from those pieces of data. While on the other hand, it is possible to adopt a method to detect an object-matter in which radio waves returned after the reflection by an object-matter are received from the radar as waveforms, and the waveforms are analyzed inside of the object-matter detection unit 118 (for example, by means of methods such as a method in which a peak(s) corresponding to the reflection by an object-matter is acquired, so that the distance is calculated from the time from the transmission until the reflection and from the speed of light; a method in which a location is calculated by the three-segment triangulation from the distances having been calculated with respect to a plurality of elements; and so forth).

While on the other hand, it is possible to adopt a method to acquire an object-matter as a final object-matter detection result in which, for example, the roadside sensor 107 is provided with an image recognition camera and a millimeter-wave radar, and an object-matter detection result is outputted from each of the sensors, so that, by consecutively receiving these pieces of information, determination is performed by comprehensively evaluating the results by means of each of the sensors (what is termed as “sensor fusion”). Moreover, it may be also possible to enhance the degrees of accuracy and/or precision even more by adopting such a manner that, with respect to an object-matter detection result, various kinds of signal processing such as tracking (lock on) processing, filtering processing and/or the like are advertently applied, whereby erroneous detection (noise) is suppressed, and the result is corrected or compensated.

As described above, the processing of object-matter detection by means of specific signal processing may be carried out inside of the roadside sensor 107; the processing may be carried out inside of the object-matter detection unit 118 by receiving raw data such as the waveforms; and the processing may also be carried out by collectively combining these processing methods. Those methods of object-matter detection change depending on a configuration of the roadside sensor 107 for which a person having ordinary skill selects, and so, it is suitable to adopt an appropriate method.

The absolute location calculation unit 119 receives an object-matter detection result from the object-matter detection unit 118, and transforms, by using placement location information 121 of the roadside unit 1, a relative location up to an object-matter into an absolute location.

A “relative location” herein designates a placement location of the roadside unit 1, and/or further, a location in a coordinate system in which a placement location of the roadside sensor 107 in the roadside unit 1 is defined as the origin.

In addition, the “absolute location” herein designates a location whose relative location is indicated by the latitude and longitude, and/or a location at which the roadside unit 1, the motor vehicle 2 and the server 4 where the abnormality determination system comprises them are commonly capable of interpreting or distinguishing the location (for example, a specific location existing within an area where the abnormality determination system targets on abnormality determination is defined as an origin in a coordinate system, and a relative location is indicated by presuming that the latitude and longitude of the origin and the definition of the coordinate system are common to each other within the constraint of the system).

As described above, it is thus possible to transform an object-matter detection result indicated by a relative location into an absolute location in accordance with an origin of the relative location and with the origin defined by the placement location information 121 of the roadside unit 1, and in accordance with the definition of the coordinate system. Various methods in which a person having ordinary skill can take into consideration may be adopted as specific transformation methods.

The abnormality determination unit 120 receives from the absolute location calculation unit 119 absolute location information of an object-matter having been detected, and performs, by comparing it with placement location information 114 of the target object 3 whose absolute location is known, abnormality determination of the roadside sensor 107 (the explanation will be made later in detail), so that the abnormality determination unit outputs a determination result. The abnormality determination apparatus 110 transmits the determination result to the server 4.

Next, the explanation will be made referring to FIG. 3 for the functions in which the motor vehicle 2 includes. The abnormality determination apparatus 106 comprises an object-matter detection unit 115, an absolute location calculation unit 116 and an abnormality determination unit 117, and further, placement location information 114 of the target object 3 is stored in the memory 105 within the motor vehicle 2.

The functions of each of the functional constituent elements of the object-matter detection unit 115, the absolute location calculation unit 116 and the abnormality determination unit 117 are implemented so that the processor 104 executes a program(s) for exerting the functions of each of the constituent portions or units.

The object-matter detection unit 115 receives a signal transmitted from the onboard surroundings monitoring sensor 101, and detects, by using the signal, an object-matter to be existing within a detection area of the onboard surroundings monitoring sensor 101. Here, various methods in which a person having ordinary skill can take into consideration may be adopted as methods of object-matter detection, similarly to the object-matter detection unit 118, and so, the explanation is omitted.

The absolute location calculation unit 116 receives the object-matter detection result from the object-matter detection unit 115, and transforms, by using absolute location information of the motor vehicle itself received from the onboard GPS 102, a relative location up to an object-matter into an absolute location.

The “relative location” herein designates a specific location of the motor vehicle 2 (for example, in the frontward center of the motor vehicle, the center of gravity of the motor vehicle, or the like), and/or further, a location in a coordinate system in which a placement location of the onboard surroundings monitoring sensor 101 in the motor vehicle 2 is defined as the origin. The definition of the “absolute location” is as exactly described above.

As described above, it is thus possible to transform the object-matter detection result indicated by the relative location into an absolute location in accordance with the origin of the relative location and with absolute location information of the motor vehicle itself obtained from the onboard GPS 102. Various methods in which a person having ordinary skill can take into consideration may be adopted as specific transformation methods.

The abnormality determination unit 117 receives from the absolute location calculation unit 116 absolute location information of an object-matter having been detected, and performs, by comparing it with placement location information 114 of the target object 3 whose absolute location is known, abnormality determination of the onboard surroundings monitoring sensor 101 (the explanation will be made later in detail), so that the abnormality determination unit outputs a determination result. The abnormality determination apparatus 106 transmits the determination result to the server 4.

<Explanation of Operations>

Operational procedures of the abnormality determination apparatus 110 and those of the abnormality determination apparatus 106 each correspond to abnormality determination methods. In addition, programs for implementing the operations of the abnormality determination apparatus 110 and the abnormality determination apparatus 106 each correspond to abnormality determination programs.

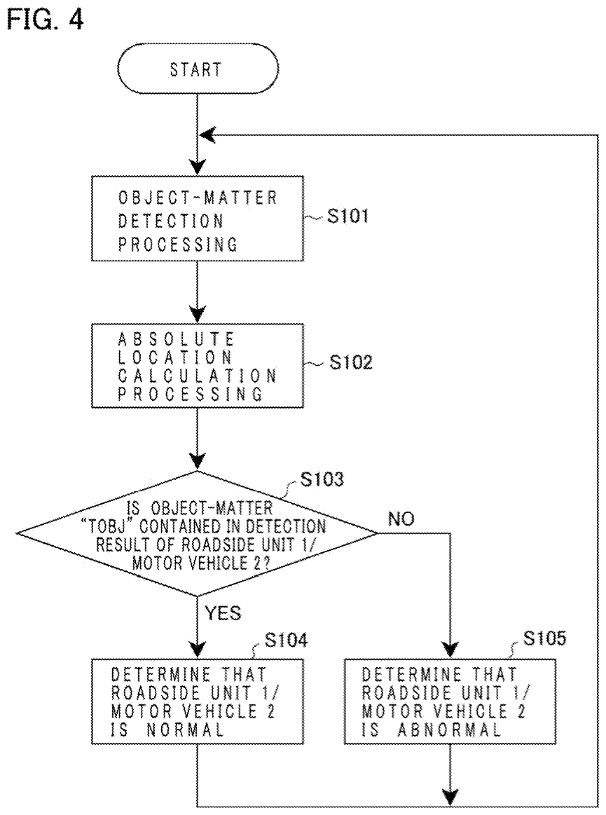

FIG. 4 is a flowchart illustrating, by way of example, the operations of the abnormality determination apparatus 110 and those of the abnormality determination apparatus 106 according to the embodiment. First, the explanation will be made referring to FIG. 4 for the operations of the abnormality determination apparatus 110, and, as for the abnormality determination apparatus 106, the explanation will be made for the difference to the abnormality determination apparatus 110.

The object-matter detection unit 118 in the abnormality determination apparatus 110 carries out the processing of Step S101.

### (Step S101: Object-Matter Detection Processing)

The object-matter detection unit 118 performs object-matter detection by using data received from the roadside sensor 107. An example of the method of the object-matter detection is as exactly described above.

The absolute location calculation unit 119 in the abnormality determination apparatus 110 carries out the processing of Step S102.

### (Step S102: Absolute Location Calculation Processing)

The absolute location calculation unit 119 calculates an absolute location of an object-matter by using an object-matter detection result having been calculated at Step S101 and placement location information 121 of the roadside unit 1. An example of the method of the absolute location calculation is as exactly described above.

The abnormality determination unit 120 in the abnormality determination apparatus 110 carries out the processing from Step S103 to Step S105.

(Step S103: Comparison with Reference Information)

The abnormality determination unit 120 compares an absolute location of an object-matter having been detected by the roadside sensor 107 calculated at Step S102 with placement location information 114 of the target object 3. As for the target object 3, its placement location is known, and thus, the target object can be utilized as reference information (what is termed as “correct answer information”). Because both of the pieces of information are indicated by absolute coordinates, it is possible to determine that the roadside sensor 107 operates normally when a detection result of the roadside sensor 107 is coincident with an absolute location of the target object 3.

Note that, as for an object-matter which can be detected by the roadside sensor 107, there generally exists a plurality of object-matters within a subject-matter area of the roadside unit 1. In such a case, a plurality of object-matters also results in existing in the detection result, and so, by generalizing the case, it is defined that abnormality determination is performed as normal “when an object-matter is contained in the detection result which is coincident with the target object 3.”

In addition, due to the tradeoffs between a detection error(s) of a sensor and detection accuracy thereof in general, the coordinates of the both parties are not made coincident with each other in a strict sense. For this reason, it is determined that both parties' absolute locations are coincident with each other, “when the distance between both parties' absolute locations themselves is at a predetermined first threshold value or less,” for example.

### (Step S104, Step S105: Output of Determination Result)

The abnormality determination unit 120 outputs, on the basis of a determination result of Step S103, a determination result such as “normal” at Step S104, when the determination result indicates normality. Meanwhile, when the determination result does not indicate normality, the abnormality determination unit 120 outputs a determination result such as “abnormal” at Step S105.

When the output processing of the determination result ends, the processing returns to Step S101, so that the following processing is repeated in an appropriate time interval.

Note that, in order to make the explanation made convenient hereinbefore, determination is performed by one kind as “abnormal” in a case in which determination is not normal; however, on the basis of a comparison result at Step S103, the determination may be performed by classifying a case in which determination is not normal into two or more kinds in the determination. For example, at Step S103, determination may be performed as a “malfunction” of the roadside sensor 107, when there exist no object-matter within a detection result of the roadside sensor 107; and determination may also be performed such as “not a malfunction, but the capability of a sensor is degraded due to axial displacement of the sensor, its contamination and/or the like” when there exists an object-matter within a detection result in a near distance to the target object 3, there exists no coincidence therewith. In the latter case, notification contents are changed by means of the server 4 which receives the determination result, and countermeasures can also be taken in such a manner that, for example, the operations of the roadside unit 1 is temporarily stopped, and the operator verifies the presence or absence of axial displacement and calibrates it for a second time and/or wipes out its contamination clean.

Next, the explanation will be made for the operations of the abnormality determination apparatus 106 by focusing on the difference from the abnormality determination apparatus 110.

The object-matter detection unit 115 in the abnormality determination apparatus 106 performs, as the processing at Step S101, object-matter detection by using data received from the onboard surroundings monitoring sensor 101. Because the details are similar to those of the abnormality determination apparatus 110, the explanation will be omitted.

The absolute location calculation unit 116 in the abnormality determination apparatus 106 calculates, as the processing of Step S102, an absolute location of an object-matter by using an object-matter detection result calculated at Step S101 and absolute location information of the motor vehicle itself received from the onboard GPS 102. Because the details are similar to those of the abnormality determination apparatus 110, the explanation will be omitted.

The abnormality determination unit 117 in the abnormality determination apparatus 106 compares, as the processing from Step S103 to Step S105, absolute locations of an object-matter detected by the onboard surroundings monitoring sensor 101 and the onboard GPS 102 each of which is calculated at Step S102 with placement location information 114 of the target object 3, and performs abnormality determination, so that a determination result is outputted. Because the details are similar to those of the abnormality determination apparatus 110, the explanation will be omitted.

### Effects of Embodiment 1

According to the embodiment as described above, the abnormality determination system performs object-matter detection by sensors on each of the roadside unit 1 and the motor vehicle 2, and compares the determination result with a placement location of the target object 3 being reference information, whereby abnormality determination on each of the sensors. According to this arrangement, determination can be performed for the presence or absence of sensor abnormality on each of the roadside unit 1 and the motor vehicle 2 without using a plurality of number of motor vehicles.

The explanation will be made for modification examples in Embodiment 1.

### Modification Example 1

In the embodiment, the target object 3 is placed at a location whose placement coordinates are made clear; however, an object-matter existing in advance may be utilized as the target object 3.

For example, when the roadside unit 1 and the motor vehicle 2 are provided with highly accurate geographic map information, utilized as the target object 3 is an object-matter which is contained in the geographic map and whose placement location is made clear (for example, a traffic sign, a pole, a guard rail or the like), whereby the roadside unit 1 and the motor vehicle 2 can make use of the highly accurate geographic map information in place of the placement location information 114 of the target object 3.

Note that, a selection method of the target object 3 is not limited to the method described above, and so, it is possible to select the target object by various methods in which a person having ordinary skill can take into consideration.

### Modification Example 2

In the embodiment, the explanation has been made for a case in which each of the functional constituent elements is implemented by software. However, as a modification example, each of the functional constituent elements may be implemented by hardware.

When each of the functional constituent elements is implemented by hardware, the abnormality determination apparatus 110 and the abnormality determination apparatus 106, and further the control device 113 in the abnormality determination system comprise electronic circuits in place of the processors 108, 104 and 111, respectively. While on the other hand, they comprise electronic circuits each in place of the processors 108, 104 and 111, and the memories 109, 105 and 112. The electronic circuits are dedicated electronic circuits for implementing the functions in each of the processors (and the memories). The electronic circuits each may also be referred to as processing circuitry.

As for the electronic circuits each, presumed are: single circuitry, complex circuitry, a programmed processor, a parallel programmed processor, a logic IC, a gate array (Gate Array, GA), an application specific integrated circuit (Application Specific Integrated Circuit, ASIC), a field-programmable gate array (Field-Programmable Gate Array, FPGA).

Each of the functional constituent elements may be implemented by one electronic circuit, or each of the functional constituent elements may be implemented by distributing into a plurality of electronic circuits.

While on the other hand, part of each of the functional constituent elements may be implemented by hardware, and the other part of each of the functional constituent elements may be implemented by software.

The processors 108, 104 and 111, and the memories 109, 105 and 112 described above are collectively called as “processing circuitry.” Namely, the functions of the abnormality determination apparatus 110 and the abnormality determination apparatus 106, and further the control device 113 are implemented by means of the respective one of processing circuitry.

### Embodiment 2

As for an abnormality determination system according to Embodiment 2, a subject matter on which abnormality determination is performed is the onboard surroundings monitoring sensor 101 provided with the motor vehicle 2, which is the same in point as Embodiment 1; however a system configuration of the abnormality determination system is different.

Hereinafter, the explanation will be made for the difference of Embodiment 2 to Embodiment 1.

<Explanation of Configurations>

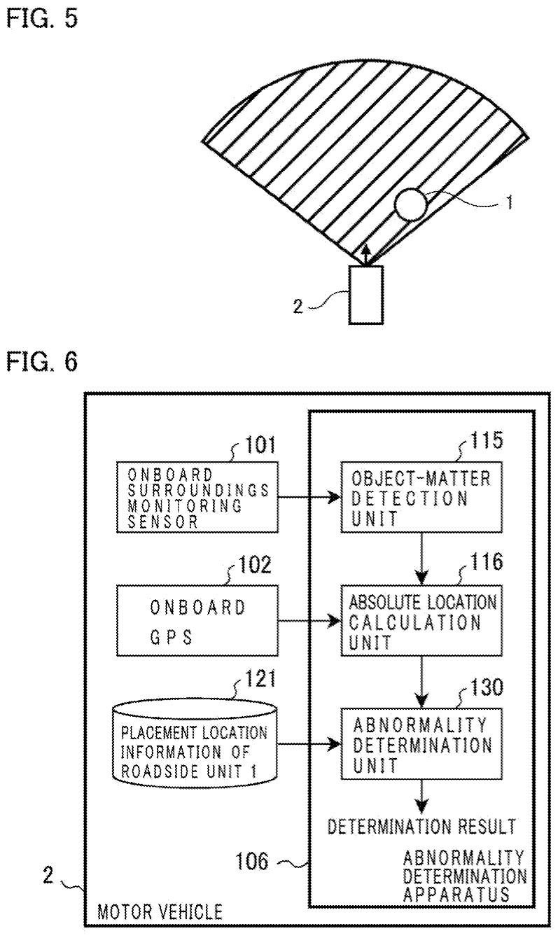

FIG. 5 shows an implementation example of the abnormality determination system according to Embodiment 2.

The abnormality determination system is constituted of the roadside unit 1, the motor vehicle 2 and a server which is not shown in the figure.

In Embodiment 2, the roadside unit 1 is used for reference information in place of the target object 3 in Embodiment 1, and determination is consecutively performed whether or not abnormality is caused in the motor vehicle 2, so that an abnormality determination result(s) is consecutively transmitted to the server, and the server notifies the determination result(s). Hereinafter, the explanation will be made for the details of each constituent element.

Basic requirements of the roadside unit 1 and those of the motor vehicle 2 are similar to Embodiment 1. However, the roadside unit 1 is an object-matter which can be detected by the onboard surroundings monitoring sensor 101 provided with the motor vehicle 2, and/or it is required for the onboard surroundings monitoring sensor 101 to have a configuration capable of detecting the roadside unit 1, which differs in point from Embodiment 1.

In addition, it is required for the roadside unit 1 to be placed at a location at which the roadside unit 1 can be detected by the onboard surroundings monitoring sensor 101, which also differs in point from Embodiment 1.

FIG. 6 is an example of a functional block diagram of the motor vehicle 2 in the abnormality determination system. The motor vehicle 2 is similar in its basic configuration to that shown in FIG. 3; however, placement location information 121 of the roadside unit 1 is stored in the memory 105 inside of the motor vehicle 2 in place of placement location information 114 of the target object 3, which differs in point from Embodiment 1. In addition, corresponding to the alteration, an abnormality determination unit 130 is included in place of the abnormality determination unit 117, which also differs in point from Embodiment 1.

Note that, in the embodiment, the roadside unit 1 is utilized as an object-matter in use for reference information, and so, the functions of the roadside unit 1 itself are not shown by FIG. 6. Namely, in the embodiment, the roadside unit 1 may be operated similarly to Embodiment 1; however, the roadside unit 1 is not necessarily be operated in such a manner, and is not necessarily be in its normal state even when it is operated.

<Explanation of Operations>

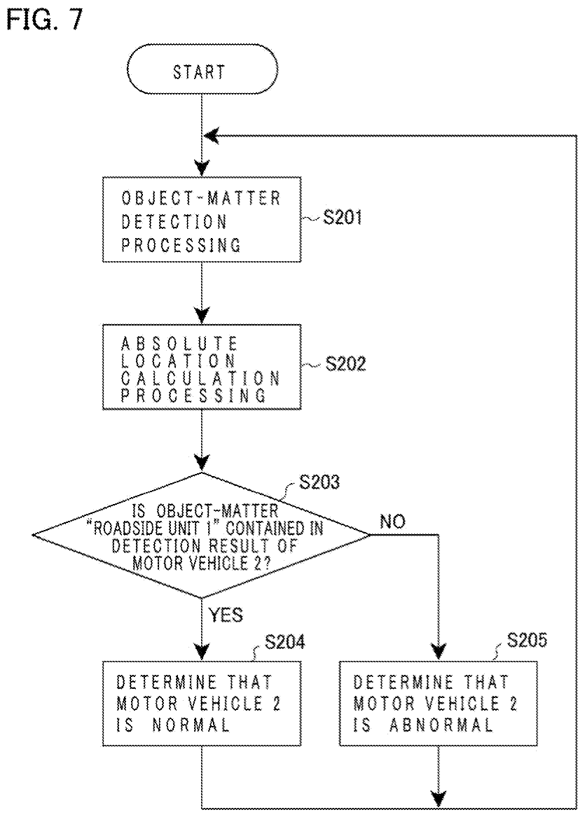

FIG. 7 is a flowchart illustrating, by way of example, the operations of the abnormality determination apparatus 106 according to Embodiment 2. The explanation will be made referring to FIG. 7 and FIG. 4 for the difference to the abnormality determination apparatus 106 according to Embodiment 1.

The object-matter detection unit 115 in the abnormality determination apparatus 106 carries out the processing of Step S201, and the absolute location calculation unit 116 therein carries out the processing of Step S202, so that an absolute location of an object-matter is calculated thereby, which are similar to the points performed in Embodiment 1.

The abnormality determination unit 130 in the abnormality determination apparatus 106 compares, as the processing of Step S203, an absolute location of the object-matter having been calculated at Step S202 with placement location information 121 of the roadside unit 1, and performs abnormality determination, which differs in point from Step S103 of FIG. 4 performed in Embodiment 1. However, the determination method is similar to that of Embodiment 1. And so, the processing of Steps S204 and S205 is carried out, so that a respective determination result is outputted; and subsequently, the processing returns to Step S201, so that the following processing is repeated in an appropriate time interval, which are similar to the points in Embodiment 1.

### Effects of Embodiment 2

According to the embodiment as described above, the abnormality determination system utilizes placement location information 121 of the roadside unit 1 as reference information in place of the target object 3, so that the abnormality determination system performs determination whether or not abnormality is caused in the motor vehicle 2. According to this arrangement, in a situation in which a roadside unit(s) and a motor vehicle(s) exist as they are in an ordinary automated driving system, the roadside unit can be utilized as a target object, so that an effect can be achieved as obtaining that an object is not newly required for the placement.

### Embodiment 3

As for an abnormality determination system according to Embodiment 3, a subject matter on which abnormality determination is performed is the roadside sensor 107 provided with the roadside unit 1, which is the same in point as Embodiment 1; however a system configuration of the abnormality determination system is different.

Hereinafter, the explanation will be made for the difference of Embodiment 3 to Embodiment 1.

<Explanation of Configurations>

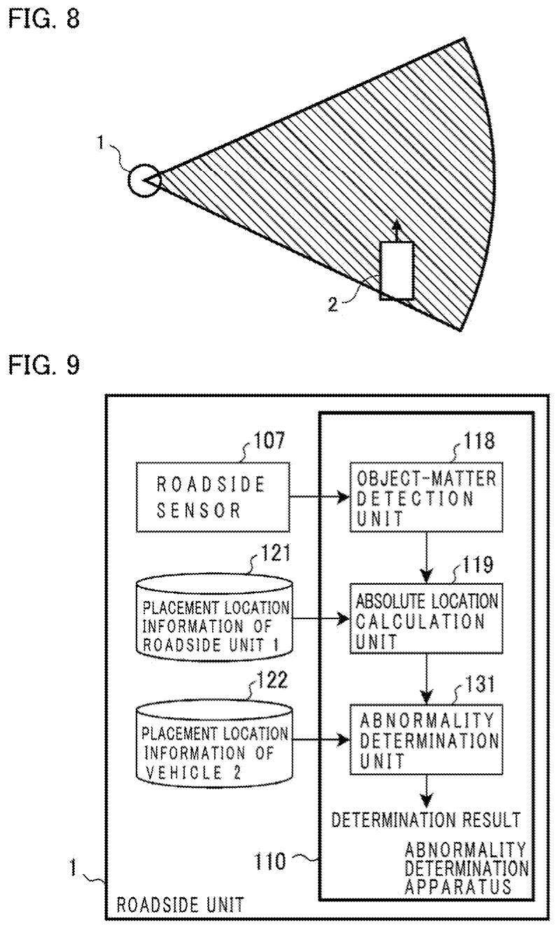

FIG. 8 shows an implementation example of the abnormality determination system according to Embodiment 3.

The abnormality determination system is constituted of the roadside unit 1, the motor vehicle 2 and a server which is not shown in the figure.

In Embodiment 2, the motor vehicle 2 is used for reference information in place of the target object 3 in Embodiment 1, and determination is consecutively performed whether or not abnormality is caused in the roadside unit 1, so that an abnormality determination result(s) is consecutively transmitted to the server, and the server notifies the determination result(s). Hereinafter, the explanation will be made for the details of each constituent element.

Basic requirements of the roadside unit 1 and those of the motor vehicle 2 are similar to Embodiment 1. However, the motor vehicle 2 is an object-matter which can be detected by the roadside sensor 107 provided with the roadside unit 1, and/or it is required for the roadside sensor 107 to have a configuration capable of detecting the motor vehicle 2, which differs in point from Embodiment 1.

In addition, it is required for the roadside unit 1 to be placed at a location at which the roadside unit 1 can detect the motor vehicle 2, which also differs in point from Embodiment 1. As a specific example, the roadside unit 1 can be placed beside a running road-route along which the motor vehicle 2 can run.

Moreover, the motor vehicle 2 consecutively transmits current location information 122 of the motor vehicle itself to the roadside unit 1 by way of its communications interface 103, which differs in point from Embodiment 1. The current location information herein designates an absolute location of the motor vehicle itself detected by its onboard GPS 102.

FIG. 9 is an example of a functional block diagram of the roadside unit 1 in the abnormality determination system according to Embodiment 3. The roadside unit 1 is similar in its basic configuration to that shown in FIG. 3; however, in place of placement location information 114 of the target object 3, current location information 122 of the motor vehicle 2 is consecutively received by way of the communications interface 103 into the memory 109 inside of the roadside unit 1, which differs in point from Embodiment 1. In addition, corresponding to the alteration, an abnormality determination unit 131 is included in place of the abnormality determination unit 120, which also differs in point from Embodiment 1.

Note that, in the embodiment, the motor vehicle 2 is utilized as an object-matter in use for reference information, and so, the functions of the motor vehicle 2 on its own are not shown by FIG. 9. Namely, in the embodiment, the motor vehicle 2 may be operated similarly to Embodiment 1; however, the motor vehicle 2 is not necessarily be operated in such a manner, and is not necessarily be in its normal state even when it is operated.

<Explanation of Operations>

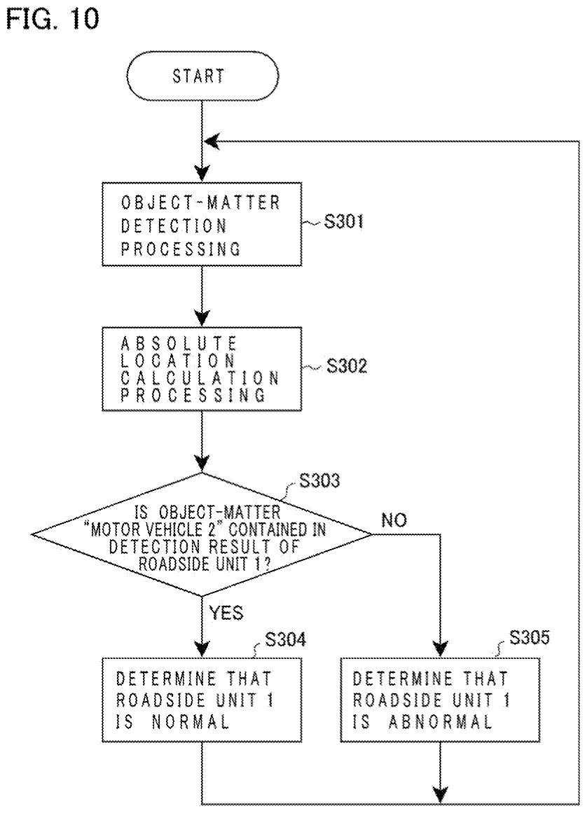

FIG. 10 is a flowchart illustrating, by way of example, the operations of the abnormality determination apparatus 110 according to Embodiment 3. The explanation will be made referring to FIG. 10 and FIG. 4 for the difference to the abnormality determination apparatus 110 according to Embodiment 1.

The object-matter detection unit 118 in the abnormality determination apparatus 110 carries out the processing of Step S301, and the absolute location calculation unit 119 therein carries out the processing of Step S302, so that an absolute location of an object-matter is calculated thereby, which are similar to the points performed in Embodiment 1.

The abnormality determination unit 131 in the abnormality determination apparatus 110 compares, as the processing of Step S303, an absolute location of the object-matter having been calculated at Step S302 with the current location information 122 of the motor vehicle 2, and performs abnormality determination, which differs in point from Step S103 of FIG. 4 performed in Embodiment 1. However, the determination method is similar to that of Embodiment 1. And thus, the processing of Steps S304 and S305 is carried out, so that a respective determination result is outputted; and subsequently, the processing returns to Step S301, so that the following processing is repeated in an appropriate time interval, which are similar to the points in Embodiment 1.

### Effects of Embodiment 3

According to Embodiment 3 as described above, the abnormality determination system utilizes the current location information 122 of the motor vehicle 2 as reference information in place of the target object 3, so that the abnormality determination system performs determination whether or not abnormality is caused in the roadside unit 1. According to this arrangement, in a situation in which a roadside unit(s) and a motor vehicle(s) exist as they are in an ordinary automated driving system, the motor vehicle(s) can be utilized as a target object(s), so that an effect can be achieved as obtaining that an object is not newly required for the placement.

The explanation will be made for modification examples in Embodiment 3.

### Modification Example 1

In the embodiment, the motor vehicle 2 is used for reference information in place of the target object 3; however, a pedestrian may also be used for the reference information in place of the motor vehicle. In that case, similarly to the embodiment, the roadside unit 1 may be placed so that its roadside sensor 107 is configured to be able to detect a pedestrian in place of the motor vehicle 2; or a pedestrian may consecutively transmit current location information to the roadside unit 1.

For example, a pedestrian installs in advance an application for use within an area of the automated driving system into a mobile terminal such as a smart telephone or the like of the pedestrian (or on the other hand, a mobile terminal to which an application is installed in advance is rented to the pedestrian), so that current location information acquired from a GPS provided with the mobile terminal can be consecutively transmitted to the roadside unit 1 by way of radio communications.

While on the other hand, not a general user but related personnel such as an inspector, the operator and/or the like are only assigned as a pedestrian in place of the target object 3, and an object-matter capable of being detected by the roadside sensor 107 is worn by those people, whereby it is also possible to take on a state in which the pedestrian can be detected more reliably in good accuracy. For example, the roadside sensor 107 is provided with an image recognition camera, and an inspector keeps a checker board in use for camera calibration or wears work clothes provided with the corresponding patterns, and the inspector walks within a detection area of the roadside unit 1 at predetermined timing, whereby abnormality determination may be performed.

Note that, a formation of the pedestrian is not limited to that described above, and so, it is possible to take on a state in which, according to various methods in which a person having ordinary skill can take into consideration, current location information of a pedestrian is made usable as reference information.

### Modification Example 2

In the embodiment, the roadside unit 1 placed in a general area is made as a subject matter, and the motor vehicle 2 which runs within the detection area is made as a subject matter; however, abnormality determination may be more accurately performed by limiting an area to a specific area.

For example, the roadside unit 1 is placed at a bus stop of an automated driving bus or the like, so that current location information of a motor vehicle such as the bus or the like which stops at the bus stop can be utilized as reference information. In this case, because the motor vehicle 2 such as a bus which stops at a place determined in advance, it is possible to take on a state in which the motor vehicle 2 can be detected more reliably in good accuracy.

Note that, a method of limiting an area, and the kinds of motor vehicles for use as pieces of reference information in the limited area are not restricted to those described above, and so, it is possible to take on a state in which, according to various methods in which a person having ordinary skill can take into consideration, current location information of the motor vehicle 2 is made usable as reference information.

### Embodiment 4

In the abnormality determination system according to Embodiment 1 and that according to Embodiment 2, it is possible to determine abnormality of the onboard surroundings monitoring sensor 101 provided with the motor vehicle 2; however, it is presumed that the onboard GPS 102 provided therewith operates normally (i.e., current location information 122 of the motor vehicle itself can be appropriately acquired). For this reason, there exists a possibility in which appropriate abnormality determination cannot be performed when abnormality is cause in the onboard GPS 102.

An abnormality determination system according to Embodiment 4 is directed at solving the problem described above, and, at a time of performing determination on the presence or absence of abnormality in the roadside unit and the motor vehicle 2, determination is performed not only on the onboard surroundings monitoring sensor 101, but also on the onboard GPS 102; and namely, an object is to identify a position where abnormality is caused.

As for a configuration of the system, it differs from Embodiment 1 in a point in which there does not exist such a target object 3, and in a point in which a plurality of roadside units is provided.

Hereinafter, the explanation will be made for the difference of Embodiment 4 to Embodiment 1.

<Explanation of Configurations>

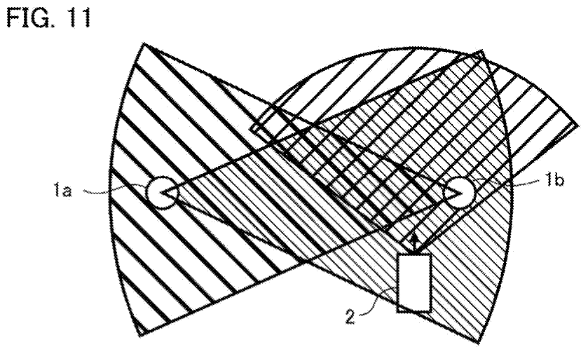

FIG. 11 shows an implementation example of the abnormality determination system according to Embodiment 4.

The abnormality determination system is constituted of roadside units 1a and 1b, the motor vehicle 2 and a server which is not shown in the figure.

In Embodiment 4, by using the roadside unit 1b as reference information, determination is firstly performed whether or not abnormality is caused in the roadside unit 1a, and subsequently, by using a detection result of the roadside unit 1a as reference information, determination is consecutively performed whether or not abnormality is caused in the onboard surroundings monitoring sensor 101 provided with the motor vehicle 2 and the onboard GPS 102 provided therewith. In addition, each of the object-matter detection results is consecutively transmitted to the server, so that each abnormality determination is performed on the server side, which notifies a determination result(s). Hereinafter, the explanation will be made for the details of each constituent element.

The roadside unit 1a is required to be placed at a location capable of detecting the roadside unit 1b and the motor vehicle 2.

It is required to configure in such a manner that the roadside unit 1b is an object-matter which can be detected by a roadside sensor 107a provided with the roadside unit 1a and by the onboard surroundings monitoring sensor 101 provided with the motor vehicle 2, and/or that the roadside sensor 107a and the onboard surroundings monitoring sensor 101 are capable of detecting the roadside unit 1b.

In addition, the roadside unit 1b is required to be placed within a detection area of the roadside sensor 107a and within that of the onboard surroundings monitoring sensor 101.

It is required to configure in such a manner that the motor vehicle 2 is an object-matter which can be detected by the roadside sensor 107a provided with the roadside unit 1a, and/or that the roadside sensor 107a is capable of detecting the motor vehicle 2.

From a viewpoint to sort out conditions on the side of an object-matter detecting sensor described above, it is required for the roadside unit 1a to have a placement and a sensor configuration capable of detecting the roadside unit 1b and the motor vehicle 2. In addition, it is required for the motor vehicle 2 have a sensor configuration capable of detecting the roadside unit 1b.

Similarly, from a viewpoint to sort out conditions on the side of a detection subject-matter (as an object-matter being detected by a sensor), it is required for the roadside unit 1b to be an object-matter which can be detected by the roadside unit 1a and the motor vehicle 2. In addition, it is required for the motor vehicle 2 to be an object-matter which can be detected by the roadside unit 1a.

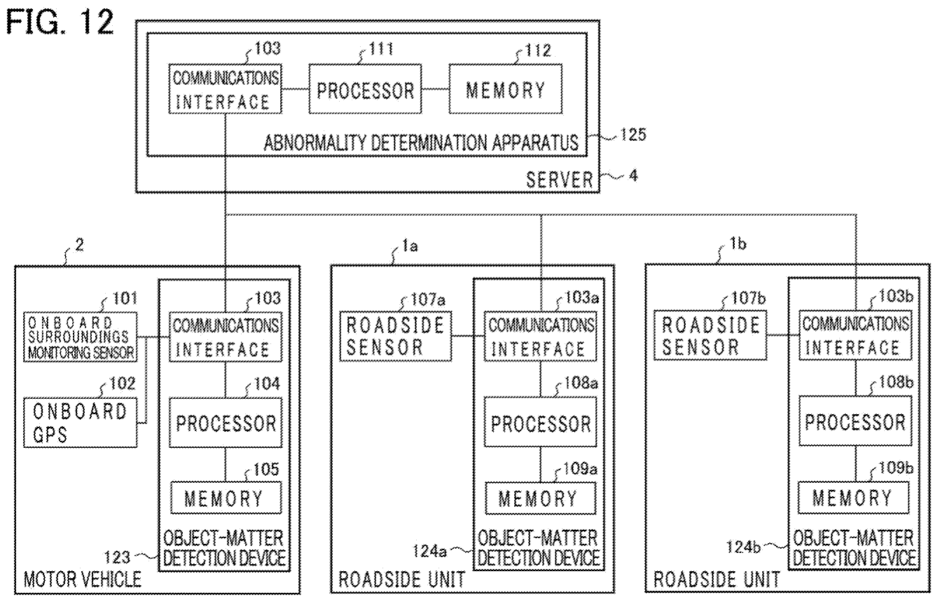

FIG. 12 is a diagram illustrating, by way of example, a hardware configuration of the abnormality determination system according to Embodiment 4. The abnormality determination system is constituted of the roadside unit 1a and the roadside unit 1b, the motor vehicle 2, and a server 4 as illustrated in FIG. 12.

Hereinafter, as for each of the functional constituent elements, the explanation will be made for the difference to the hardware configuration example of the abnormality determination system according to Embodiment 1 illustrated in FIG. 2.

The roadside unit 1a is similar in its basic configuration to the roadside unit 1 in Embodiment 1 as shown in FIG. 12; however, the roadside unit 1a comprises an object-matter detection device 124a in place of the abnormality determination apparatus 110, which differ in point from Embodiment 1.

To be specific, the roadside unit 1a comprises the roadside sensor 107a and the object-matter detection device 124a, and then the object-matter detection device 124a comprises a processor 108a, a memory 109a and a communications interface 103a.

The roadside unit 1b is similarly configured as the roadside unit 1a, so that the roadside unit 1b comprises a roadside sensor 107b and an object-matter detection device 124b as shown in FIG. 12, and then the object-matter detection device 124b comprises a processor 108b, a memory 109b and a communications interface 103b.

The object-matter detection device 124a and the object-matter detection device 124b transmit respective object-matter detection results having been acquired by the roadside sensor 107a and the roadside sensor 107b toward an abnormality determination apparatus 125 inside of the server 4.

Note that, the object-matter detection devices 124a and 124b each may be mounted inside of the roadside unit 1a and the roadside unit 1b in forms in which the object-matter detection devices are integrally made with their respective other constituent elements, or in forms in which the object-matter detection devices cannot be separated from their respective other constituent elements; or the object-matter detection devices 124a and 124b may also be mounted in forms in which the object-matter detection devices can be detached from their respective other constituent elements, or in forms in which the object-matter detection devices can be separated from their respective other constituent elements.

As described above, in Embodiment 4, the roadside unit 1b is used as reference information at a time when the roadside unit 1a performs abnormality determination. For this reason, though the roadside unit 1b may be operated similarly to the roadside unit 1a, the roadside unit 1b is not necessarily be operated in such a manner, and is not necessarily be in its normal state even when it is operated.

The motor vehicle 2 is similar in its configuration to Embodiment 1 as shown in FIG. 12; however, the motor vehicle 2 comprises an object-matter detection device 123 in place of the abnormality determination apparatus 106, which differs in point from Embodiment 1.

To be specific, the motor vehicle 2 comprises the onboard surroundings monitoring sensor 101 and the onboard GPS 102, and the object-matter detection device 123; and then the object-matter detection device 123 comprises a processor 104, a memory 105 and a communications interface 103.

The object-matter detection device 123 transmits an object-matter detection result having been acquired by the onboard surroundings monitoring sensor 101 and the onboard GPS 102, and further absolute location information of the motor vehicle itself having been acquired by the onboard GPS 102 toward the abnormality determination apparatus 125 inside of the server 4.

Note that, the object-matter detection device 123 may be mounted inside of the motor vehicle 2 in a form in which the object-matter detection device is integrally made with its other constituent elements, or in a form in which the object-matter detection device cannot be separated from them; or the object-matter detection device 123 may also be mounted in a form in which the object-matter detection device can be detached from them, or in a form in which the object-matter detection device can be separated from them.

The server 4 is similar in its configuration to Embodiment 1 as shown in FIG. 12; however, the server 4 comprises the abnormality determination apparatus 125 in place of the control device 113, which differs in point from Embodiment 1. To be specific, the server 4 comprises the abnormality determination apparatus 125, and then the abnormality determination apparatus 125 comprises a processor 111, a memory 112 and a communications interface 103.

The abnormality determination apparatus 125 performs determination of the presence or absence of abnormality on each of the roadside sensor 107a, the onboard surroundings monitoring sensor 101 and the onboard GPS 102, on the basis of object-matter detection results trasmitted from the roadside units 1a and 1b, that transmitted from the motor vehicle 2, and further on that of absolute location information transmitted from the motor vehicle 2 itself.

From that time onward, the server 4 notifies a determination result(s) by means of various kinds of methods similarly to those in Embodiment 1.

Note that, the abnormality determination apparatus 125 may be mounted inside of the server 4 in a form in which the abnormality determination apparatus is integrally made with its other constituent elements, or in a form in which the abnormality determination apparatus cannot be separated from them; or the abnormality determination apparatus 125 may also be mounted in a form in which the abnormality determination apparatus can be detached from them, or in a form in which the abnormality determination apparatus can be separated from them.

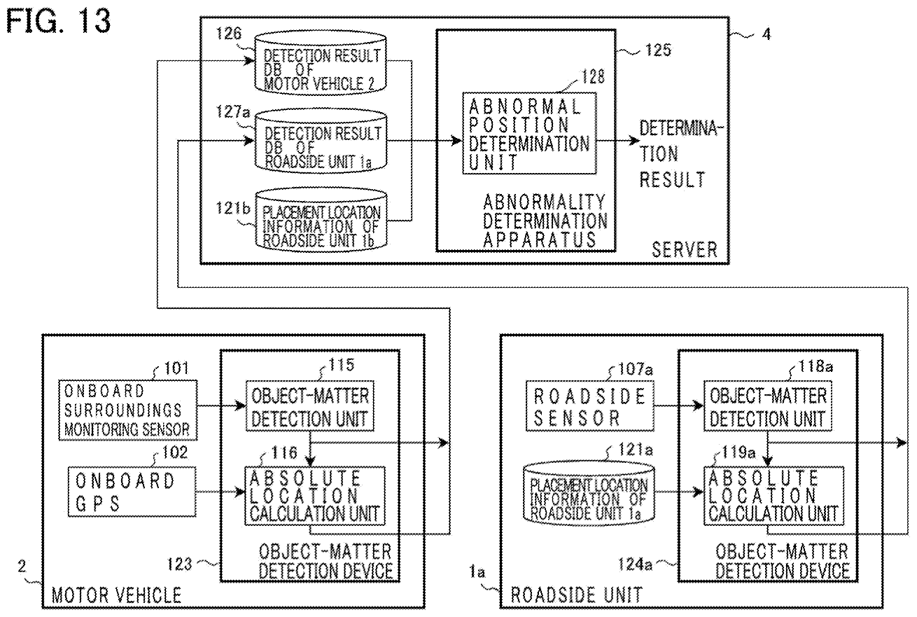

FIG. 13 is an example of a functional block diagram of the abnormality determination system according to Embodiment 4. The explanation will be made referring to FIG. 13 for a configuration of the abnormality determination system.

The abnormality determination system is constituted of the roadside units 1a and 1b, the motor vehicle 2 and the server 4 as described above. Note that, as described above, the roadside unit 1b is used as the reference information, and so, the functions of the roadside unit 1b itself are not shown in the figure.

Next, the explanation will be made for the functions in which the roadside unit 1a includes. The object-matter detection device 124a comprises an object-matter detection unit 118a and an absolute location calculation unit 119a, and further, placement location information 121a of the roadside unit 1a is stored in the memory 109a inside of the roadside unit 1a.

Note that, the functions of the object-matter detection unit 118a and those of the absolute location calculation unit 119a are basically similar to the functions of the object-matter detection unit 118 and those of the absolute location calculation unit 119 in Embodiment 1; however, the object-matter detection unit 118a transmits its object-matter detection result not only to the absolute location calculation unit 119a but also to the server 4, which differs in point from Embodiment 1. In addition, the absolute location calculation unit 119a transmits its absolute location information of an object-matter having been calculated to the server 4, which differs in point from Embodiment 1.

The functions of each of the functional constituent elements of the object-matter detection unit 118a and the absolute location calculation unit 119a are implemented so that the processor 108a executes a program(s) for exerting the functions of each of the constituent portions or units.

In addition, as also for the functions of the roadside unit 1b, the functions are similar to those of the roadside unit 1a, so that the roadside unit 1b takes on the configuration in which the symbol “a” is replaced by the symbol “b” in the aforementioned explanation.

Next, the explanation will be made referring to FIG. 13 for the functions in which the motor vehicle 2 includes. The object-matter detection device 123 comprises the object-matter detection unit 115 and the absolute location calculation unit 116.

The functions of the object-matter detection unit 115 and those of the absolute location calculation unit 116 are basically similar to the functions of the object-matter detection unit 115 and those of the absolute location calculation unit 116 in Embodiment 1; however, similarly to the object-matter detection unit 118a and the absolute location calculation unit 119a, an output of each in the unit blocks is also transmitted to the server 4, which differs in a point from Embodiment 1.

The functions of each of the functional constituent elements of the object-matter detection unit 115 and the absolute location calculation unit 116 are implemented so that the processor 104 executes a program(s) for exerting the functions of each of the constituent portions or units.

Subsequently, the explanation will be made referring to FIG. 13 for the functions in which the server 4 includes. The abnormality determination apparatus 125 comprises an abnormal position determination unit 128. Moreover, detection results received from the roadside units 1a and 1b are stored in the memory 112 inside of the server 4, in a state in which they are associated with respective detection times (time stamping), as detection result databases (a “database” is abbreviated as a “DB,” for brevity in the FIGS. 127a, and 127b (which is not shown in the figure). Similarly, a detection result and absolute location information of the motor vehicle itself received from motor vehicle 2 are stored as a detection result database 126.

Here, as for the detection results, included in both are: the object-matter detection results (each including the information related to a relative location of an object-matter) being outputs of the object-matter detection units 115 and 118a, and an object-matter detection unit 118b (not shown in the figures) of the roadside unit 1b; and pieces of absolute location information of an object-matter(s) being outputs of the absolute location calculation units 116 and 119a, and an absolute location calculation unit 119b (not shown in the figures) of the roadside unit 1b.

Moreover, placement location information 121b of the roadside unit 1b is stored not only in the memory 109b inside of the roadside unit 1b, but also in the memory 112 inside of the server 4.

Here, in the memory 112, not only the placement location information 121b of the roadside unit 1b but also placement location information 121a of the roadside unit 1a may be collectively stored.

The abnormal position determination unit 128 determines the presence or absence of abnormality on each of the roadside unit 1a, the onboard surroundings monitoring sensor 101 and the onboard GPS 102 by using the information of the detection result database 127a of the roadside unit 1a, that of the detection result database 126 of the motor vehicle 2 and that of the placement location information 121b of the roadside unit 1b.

Subsequently, the server 4 performs notification of a determination result being an output of the abnormal position determination unit 128 by various kinds of methods in a similar manner to Embodiment 1. For example, an instruction of emergency stoppage is transmitted together with a determination result(s) from the server 4 to the motor vehicle 2, and then, the motor vehicle 2 performs its automated driving by using a normal one between the onboard surroundings monitoring sensor 101 and the onboard GPS 102 provided with the motor vehicle and by using a roadside unit(s) in the surroundings, so that it becomes possible for the motor vehicle 2 to retract toward an emergency evacuation place.

As described above, notification contents may be changed in accordance with an abnormal position. As for the notification contents, they are not limited to those; and so, various methods in which a person having ordinary skill can take into consideration may be adopted.

<Explanation of Operations>

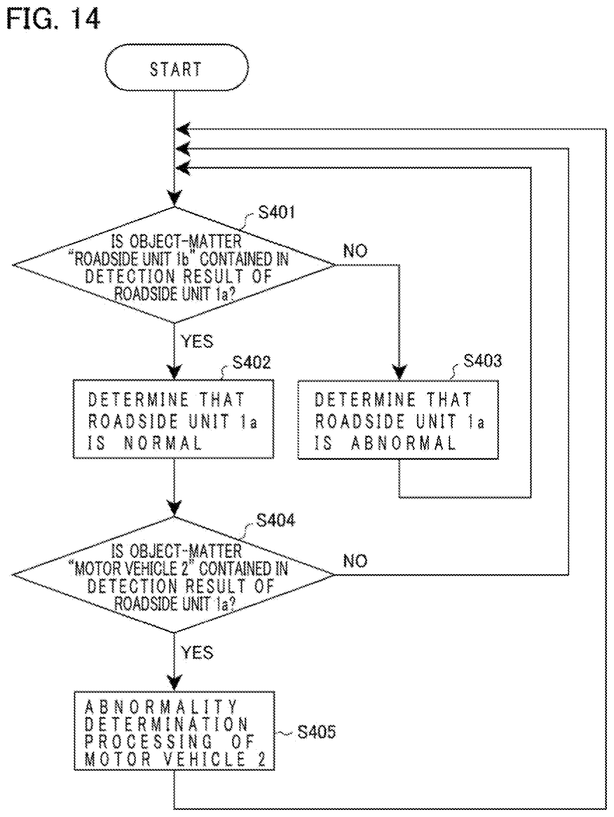

FIG. 14 is a flowchart illustrating, by way of example, the operations of the abnormality determination apparatus 125 according to Embodiment 4. The explanation will be made referring to the figure for the operations of the abnormality determination apparatus 125.

The abnormal position determination unit 128 in the abnormality determination apparatus 125 carries out the processing from Steps S401 through S405.

### (Step S401: Abnormality Determination Processing of Roadside Unit 1a)

The abnormal position determination unit 128 performs abnormality determination of the roadside unit 1a by using the detection result database 127a of the roadside unit 1a in which pieces of data received from the object-matter detection unit 118a provided with the roadside unit 1a and the absolute location calculation unit 119a provided therewith are stored, and by using placement location information 121b of the roadside unit 1b (the server 4 comprises both of them).

To be specific, the placement location information 121b of the roadside unit 1b is defined as reference information, which is compared with a detection result(s) stored in the detection result database 127a of the roadside unit 1a. Because the method of the comparison is similar to Step S103 of FIG. 4 in Embodiment 1, the details of the method will be omitted.

When the roadside unit 1b is included in the detection result(s) of the roadside unit 1a as a result of the comparison, determination is performed as “normal.”

### (Steps S402 and S403: Outputs of Determination Results)

The abnormal position determination unit 128 outputs a determination result as “normal” at Step S402 on the basis of the determination result at Step S401 when it is normal. In addition, the abnormal position determination unit 128 outputs a determination result as “abnormal” at Step S403 when the determination result at Step S401 is not normal. Note that, a point in which the determination may be performed by classifying a case where determination is not normal into two or more kinds in the determination is similar to Steps S104 and S105 of FIG. 4 in Embodiment 1, and so, the details of the point will be omitted.

When Step S402 is executed (when determined as “normal”) as a result of the comparison, the processing proceeds to Step S404. In addition, when Step S403 is executed (when determined as “abnormal”), the processing returns to Step S401. Namely, when abnormality is caused in the roadside unit 1a, abnormality determination on the side of the motor vehicle 2 does not start, and so, determination of Step S401 is repeated in an appropriate time interval until the determination is performed as “normal.”

For example, when determination is performed so that the roadside unit 1a is abnormal at Step S403, countermeasures are promoted to the operator by means of notification processing of the server 4 for the requirements of repair, replacement and/or the like of the roadside unit 1a, so that it is possible to take action to regain a state to be determined as normal. As for the notification method and its contents at the time when abnormality is caused, the measures are not limited to those as exactly described above, and so, various methods in which a person having ordinary skill can take into consideration may be adopted.

### (Step S404: Start Determination of Abnormality Determination Processing on Motor Vehicle 2)

The abnormal position determination unit 128 performs determination whether or not the motor vehicle 2 exists within a detection area of the roadside unit 1a by using the detection result database 127a of the roadside unit 1a and by using the detection result database 126 of the motor vehicle 2 in which pieces of data received from the object-matter detection unit 115 provided with the motor vehicle 2 and the absolute location calculation unit 116 provided therewith are stored (the server 4 comprises both of them).

To be specific, by utilizing the determination which has already been performed so that the roadside unit 1a is normal at Step S401, the abnormal position determination unit 128 verifies whether or not an object-matter corresponding to an object-matter “motor vehicle 2” is contained in a detection result(s) stored in the detection result database 127a of the roadside unit 1a.

Here, the explanation will be made for examples of specific verification methods. As described above, the roadside unit 1a is placed at a location capable of detecting the roadside unit 1b and the motor vehicle 2, and also is consecutively performing the transmission of object-matter detection results to abnormality determination apparatus 125 inside of the server 4. For this reason, at timing when the motor vehicle 2 enters into a detection area of the roadside unit 1a, it becomes possible to verify that an object-matter is increased or added to a detection result of the roadside unit 1a. According to the manner described above, determination is performed so that the motor vehicle 2 exists within the detection area of the roadside unit 1a.

Note that, the verification methods are not limited to those.

For example, determination may be performed so that the motor vehicle 2 exists within the detection area when the roadside unit 1a is provided with geographic map information in the surroundings of its placement area, and when a new object-matter is detected and further when the object-matter exists within the area where the motor vehicle 2 can run on the geographic map (for example, when the roadside unit 1a is placed at an intersection and when a new object-matter exists on a sidewalk on the geographic map, it is determined that the object-matter is not a motor vehicle; whereas, it is determined that the object-matter is a motor vehicle when the object-matter exists on a roadway, and so forth).

While on the other hand, when the roadside unit 1a is provided with an image recognition camera as the roadside sensor 107a, and when a new object-matter is detected and further when attribute information of the object-matter belongs to a “motor vehicle,” a “four-wheeled automotive vehicle” or the like, determination may be performed so that the motor vehicle 2 exists within the detection area.

While yet on the other hand, it may be so arranged that the motor vehicle 2 is an automated driving motor vehicle managed by an operation control system, and that determination is performed so that the motor vehicle 2 exists within a detection area of the roadside unit 1a when the roadside unit 1a detects a new object-matter at the timing of scheduled running of the motor vehicle 2, upon the plan based on a motor vehicle operation plan or the like, which runs within the detection area of the roadside unit 1a.

Other than that, according to a combination of these methods and/or by means of various methods in which a person having ordinary skill can take into consideration, it is possible to verify that the motor vehicle 2 enters within the detection area of the roadside unit 1a.

As a result of the verification, when an object-matter “motor vehicle 2” is contained in a detection result of the roadside unit 1a, determination is performed so that the motor vehicle 2 exists within a detection area of the roadside unit 1a, and then, the processing proceeds to Step S405. Meanwhile, when such an object-matter is not included, determination is performed so that the motor vehicle 2 does not exist within a detection area of the roadside unit 1a, and then, the processing returns to Step S401. Namely, in accordance with a case in which the motor vehicle 2 enters within the detection area of the roadside unit 1a, abnormality determination of the motor vehicle 2 starts.

### (Step S405: Abnormality Determination Processing of Motor Vehicle 2)

The abnormal position determination unit 128 performs abnormality determination of the motor vehicle 2 by using the detection result database 127a of the roadside unit 1a and the detection result database 126 of the motor vehicle 2 (as will be described later).

When determination processing of the motor vehicle 2 is ended, the processing returns to Step S401, so that the following processing is repeated in an appropriate time interval.

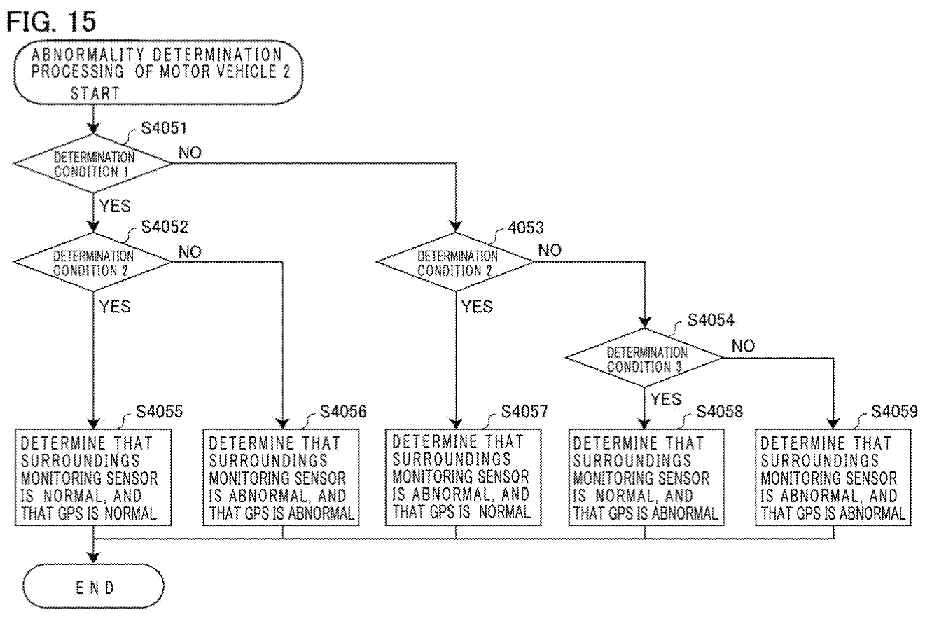

Next, the explanation will be made in detail referring to FIG. 15 for the operations at Step S405 in FIG. 14. FIG. is a flowchart illustrating, by way of example, the operations of the abnormality determination processing of the motor vehicle 2 at Step S405 according to Embodiment 4.

At Step S405, the processing is carried out from Step S4051 to Step S4059.

(Step S4051: Comparison with Absolute Location of Object-matter “Roadside Unit 1b”)

At Step S4051, an object-matter “roadside unit 1b” contained in a detection result stored in the detection result database 127a of the roadside unit 1a is defined as reference information, and the reference information is compared with a detection result stored in the detection result database 126 of the motor vehicle 2.

To be specific, because the roadside unit 1a is placed so that it can detect the roadside unit 1b as described above, and also because the roadside unit 1a has already been determined as normal at Step S401, an object-matter as the “roadside unit 1b” is contained in the detection result of the roadside unit 1a. By defining this as reference information, the reference information is compared with a detection result stored in the detection result database 126 of the motor vehicle 2 at a corresponding time.

Here, as described above, the motor vehicle 2 is capable of detecting the roadside unit 1b, and also, a placement location of the roadside unit 1a and that of the roadside unit 1b are in vicinity to each other, and yet also, determination has already been performed at Step S404 so that the motor vehicle 2 exists within the detection area of the roadside unit 1a. For these reasons, if the onboard surroundings monitoring sensor 101 provided with the motor vehicle 2 and the onboard GPS 102 provided therewith are both normal, the roadside unit 1b is contained in the detection result of the motor vehicle 2 at the timing of executing Step S4051.

Therefore, as a “determination condition 1,” a determination condition whether “by defining information of an object-matter ‘roadside unit 1b’ contained in a detection result of the roadside unit 1a as reference information, is the reference information coincident with information of an object-matter ‘roadside unit 1b’ contained in a detection result of the motor vehicle 2?” is set. Because the determination method is similar to Step S103 of FIG. 4 in Embodiment 1, the details of the method will be omitted.

When the determination condition 1 is satisfied, the processing proceeds to Step S4052; and when the determination condition 1 is not satisfied, the processing proceeds to Step S4053.

(Step S4052: Comparison with Absolute Location of Object-matter “Motor Vehicle 2”)

At Step S4052, by defining information of an object-matter “motor vehicle 2” contained in a detection result stored in the detection result database 127a of the roadside unit 1a as reference information, the reference information is compared with absolute location information of the motor vehicle 2 stored in the detection result database 126 of the motor vehicle 2.

To be specific, because determination has already been performed so that the roadside unit 1a is normal, and also that the roadside unit 1a detects the motor vehicle 2 at Steps S401 and S404, an object-matter as the “motor vehicle 2” being detected is defined as reference information, the reference information is compared with absolute location information of the motor vehicle itself stored in the detection result database 126 of the motor vehicle 2 at a corresponding time.

Here, if the onboard GPS 102 provided with the motor vehicle 2 is normal, absolute location information of the motor vehicle 2 at the timing when Step S4052 is executed is coincident with absolute location information of the motor vehicle 2 being detected by the roadside unit 1a. Therefore, as a “determination condition 2,” a determination condition whether “by defining information of an object-matter ‘motor vehicle 2’ contained in a detection result of the roadside unit 1a as reference information, is the reference information coincident with absolute location information of the motor vehicle 2?” is set. Because the determination method is similar to Step S103 of FIG. 4 in Embodiment 1, the details of the method will be omitted.

When the determination condition 2 is satisfied, the processing proceeds to Step S4055; and when the determination condition 2 is not satisfied, the processing proceeds to Step S4056.

### (Step S4055: Output of Determination Result)

On the basis of the determination result of Step S4052, when the determination condition 2 is satisfied (namely, when both of the determination condition 1 and the determination condition 2 are satisfied), absolute location information of the motor vehicle 2 is coincident with the reference information in accordance with the determination condition 2, and thus, this means that the onboard GPS 102 for calculating absolute location information is normal.

Moreover, in accordance with the determination condition 1, information of an object-matter “roadside unit 1b” being detected by the motor vehicle 2 is coincident with the reference information, and thus, this means that the onboard surroundings monitoring sensor 101 for performing object-matter detection is also normal.

Therefore, at Step S4055, a determination result such as “the onboard surroundings monitoring sensor 101 is normal, and also the onboard GPS 102 is normal” is outputted, so that the operations of Step S405 in FIG. 14 end.

### (Step S4056: Output of Determination Result)

On the basis of the determination result of Step S4052, when the determination condition 2 is not satisfied (namely, when the determination condition 1 is satisfied, but the determination condition 2 is not satisfied), absolute location information of the motor vehicle 2 is not coincident with the reference information in accordance with the determination condition 2, and thus, this means that the onboard GPS 102 for calculating absolute location information is abnormal.

Nevertheless, information of an object-matter “roadside unit 1b” being detected by the motor vehicle 2 is coincident with the reference information, which indicates that the onboard surroundings monitoring sensor 101 for performing object-matter detection performs an output as an erroneous result, and that the result is transformed into an absolute location by using the onboard GPS 102 in an abnormal state; and so, as a result, this means that the absolute location is coincident with the reference information by chance.

Therefore, at Step S4056, a determination result such as “the onboard surroundings monitoring sensor 101 is abnormal, and also the onboard GPS 102 is abnormal” is outputted, so that the operations of Step S405 in FIG. 14 end.

(Step S4053: Comparison with Absolute Location of Object-matter “Motor Vehicle 2”)

At Step S4053, abnormality determination of the onboard GPS 102 is performed in accordance with the determination condition 2, similarly to that at Step S4052.

When the determination condition 2 is satisfied, the processing proceeds to Step S4057; and when the determination condition 2 is not satisfied, the processing proceeds to Step S4054.

### (Step S4057: Output of Determination Result)

On the basis of the determination result of Step S4053, when the determination condition 2 is satisfied (namely, when the determination condition 1 is not satisfied, but the determination condition 2 is satisfied), absolute location information of the motor vehicle 2 is coincident with the reference information in accordance with the determination condition 2, and thus, this means that the onboard GPS 102 for calculating absolute location information is abnormal.

However, in accordance with the determination condition 1, an object-matter “roadside unit 1b” being detected by the motor vehicle 2 is not coincident with the reference information, this means that the onboard surroundings monitoring sensor 101 for performing object-matter detection is abnormal.

Therefore, at Step S4057, a determination result such as “the onboard surroundings monitoring sensor 101 is abnormal, and also the onboard GPS 102 is normal” is outputted, so that the operations of Step S405 in FIG. 14 end.

(Step S4054: Comparison with Relative Location of Object-matter “Roadside Unit 1b”)

At Step S4054, by defining a relative location of an object-matter “roadside unit 1b” contained in a detection result stored in the detection result database 127a of the roadside unit 1a as reference information, the comparison is performed with a detection result stored in the detection result database 126 of the motor vehicle 2.

To be specific, in the detection result of the roadside unit 1a described above, an object-matter of the “roadside unit 1b” and that of the “motor vehicle 2” are contained. By defining a relative location of these parties (namely, the relationship of relative locations between the motor vehicle 2 and the roadside unit 1b) as reference information, the comparison is performed with a detection result at the corresponding time stored in the detection result database 126 of the motor vehicle 2.

Here, if the onboard surroundings monitoring sensor 101 provided with the motor vehicle 2 is normal at the timing when Step S4054 is executed, a relative location between an object-matter “roadside unit 1b” being detected by the motor vehicle 2 and the motor vehicle itself is coincident with a relative location between an object-matter “roadside unit 1b” being detected by the roadside unit 1a and an object-matter “motor vehicle 2” being detected thereby (note that, in accordance with the result of Step S4053, the onboard GPS 102 is abnormal, and thus, the transformation from a relative location into an absolute location cannot be appropriately performed, so that absolute locations of the both parties are not coincident with each other).

Therefore, as a “determination condition 3,” a determination condition whether “by defining relative location information between an object-matter ‘roadside unit 1b’ and an object-matter ‘motor vehicle 2’ contained in a detection result of the roadside unit 1a as reference information, is the reference information coincident with relative location information between the object-matter ‘roadside unit 1b’ and the motor vehicle itself contained in a detection result of the motor vehicle 2?” is set. Because the determination method is similar to Step S103 of FIG. 4 in Embodiment 1, the details of the method will be omitted.

When the determination condition 3 is satisfied, the processing proceeds to Step S4058; and when the determination condition 3 is not satisfied, the processing proceeds to Step S4059.

### (Step S4058: Output of Determination Result)

On the basis of the determination result of Step S4054, when the determination condition 3 is satisfied (namely, the determination condition 1 and the determination condition 2 are not satisfied, but the determination condition 3 is satisfied), a relative location between the object-matter “roadside unit 1b” being detected by the motor vehicle 2 and the motor vehicle itself is coincident with the reference information in accordance with the determination condition 3, and thus, this means that the onboard surroundings monitoring sensor 101 for performing object-matter detection is normal.

In addition, in accordance with the determination condition 2, absolute location information of the motor vehicle 2 is not coincident with the reference information, and thus, this means that the onboard GPS 102 for calculating absolute location information is abnormal.

In this case, in the determination condition 1, an absolute location of the object-matter “roadside unit 1b” being detected by the motor vehicle 2 and that of the motor vehicle itself are not coincident with the reference information, which matches with the results of the aforementioned determination condition 2 and determination condition 3.

Therefore, at Step S4058, a determination result such as “the onboard surroundings monitoring sensor 101 is normal, and also the onboard GPS 102 is abnormal” is outputted, so that the operations of Step S405 in FIG. 14 is ended.

### (Step S4059: Output of Determination Result)

On the basis of the determination result of Step S4054, when the determination condition 3 is not satisfied (namely, any one of the determination condition 1, the determination condition 2 and the determination condition 3 is not satisfied), a relative location between the object-matter “roadside unit 1b” being detected by the motor vehicle 2 and the motor vehicle itself is not coincident with the reference information in accordance with the determination condition 3, and thus, this means that the onboard surroundings monitoring sensor 101 for performing object-matter detection is abnormal.

In addition, in accordance with the determination condition 2, absolute location information of the motor vehicle 2 is not coincident with the reference information, and thus, this means that the onboard GPS 102 for calculating absolute location information is abnormal.

In this case, in the determination condition 1, an absolute location of the object-matter “roadside unit 1b” being detected by the motor vehicle 2 and that of the motor vehicle itself are not coincident with the reference information, which matches with the results of the aforementioned determination condition 2 and determination condition 3.

Therefore, at Step S4059, a determination result such as “the onboard surroundings monitoring sensor 101 is abnormal, and also the onboard GPS 102 is abnormal” is outputted, so that the operations of Step S405 in FIG. 14 is ended.

The series of determination from the determination condition 1 to the determination condition 3 carried out by the processing of Step S405 described above is an example, and so, if equivalent determination can be carried out, the order of determination flows may be appropriately exchanged with each other, all of the determination conditions may be collectively determined. As for the method of carrying out the determination, various methods in which a person having ordinary skill can take into consideration may be adopted.

### Effects of Embodiment 4

According to Embodiment 4 as described above, the abnormality determination system comprises a plurality of number of roadside units in place of the target object 3. First, in the abnormality determination system, the detection result database 127a of the roadside unit 1a is compared with placement location information 121b of the roadside unit 1b, so that determination is performed whether or not abnormality is caused in the roadside unit 1a; and from that time onward, a detection result of the roadside unit 1a is compared with the detection result database 126 of the motor vehicle 2, whereby determination is performed whether or not abnormality is caused with respect to each of the onboard surroundings monitoring sensor 101 provided with the motor vehicle 2 and the onboard GPS 102 provided therewith.

According to this arrangement, an effect can be achieved as obtaining that, while the abnormality determination is performed in a situation where the plurality of number of roadside units and a motor vehicle(s) exist as they are in an ordinary automated driving system, it is not necessary newly place an object-matter, and another effect can be achieved as obtaining that, in addition to the effects of Embodiments 2 and 3, determination on each of the onboard surroundings monitoring sensor provided with the motor vehicle and the onboard GPS 102 provided therewith can be distinguishably performed.

The explanation will be made for other configurations of the embodiment, namely, modification examples therein.

### Modification Example 1

In the embodiment, the roadside unit 1a uses the roadside unit 1b as the reference information at the time when abnormality determination by the roadside unit 1a is performed; however, the roadside unit 1b can make use of itself by operating it as a roadside unit.

For example, in the implementation example of the abnormality determination system shown in FIG. 11, the motor vehicle 2 is not detected because the motor vehicle 2 does not exist within a detection area of the roadside unit 1b;

however, the roadside sensor 107b provided with the roadside unit 1b can detect the motor vehicle 2 in a case in which the motor vehicle 2 enters within the detection area of the roadside unit 1b from that time onward, and/or a case or the like in which a placement location of the roadside unit 1b and/or its placement direction differ from those of FIG. 11 so that the motor vehicle 2 becomes in a situation being capable for the detection.

In these cases, in addition to the conditions related to the roadside units 1a and 1b described above, it is necessary to configure in such a manner that the roadside unit 1a is an object-matter which can be detected by the roadside sensor 107b provided with the roadside unit 1b, and/or that the roadside sensor 107b is capable of detecting the roadside unit 1a. Moreover, the roadside unit 1a is required to be placed within the detection area of the roadside sensor 107b.

From a viewpoint to sort out conditions on the side of an object-matter detecting sensor for a second time, it is required for the roadside unit 1b to have its placement and its sensor configuration capable of detecting the roadside unit 1a, in addition to the conditions described above.

Similarly, from a viewpoint to sort out conditions on the side of a detection subject-matter (as an object-matter being detected by a sensor) for a second time, it is required for the roadside unit 1a to be an object-matter which can be detected by the roadside unit 1b, in addition to the conditions described above.

At this time, similarly to the detection result database 127a of the roadside unit 1a in the functional block diagram shown in FIG. 13, it is possible to perform abnormality determination by providing a detection result database 127b of the roadside unit 1b (which is not shown in the figure, applicable hereinafter in a similar fashion) in the server 4, and by using the detection result database 127b which is then combined together with the detection result database 127a of the roadside unit 1a.

However, because it is presumed in this case that determination has been performed so that the roadside unit 1b is normal, placement location information 121a of the roadside unit 1a is provided in the server 4 in the functional block diagram shown in FIG. 13, and, similarly to a case in which the abnormality determination of the roadside unit 1a is performed at Step S401 of FIG. 14, the placement location information 121a of the roadside unit 1a is defined as reference information, so that the reference information is compared with a detection result stored in in the detection result database 127b of the roadside unit 1b, whereby the abnormality determination of the roadside unit 1b is performed. Namely, the roadside units 1a and 1b utilize respective pieces of reference information for their mutual abnormality determinations by defining mutual pieces of placement location information as their respective pieces of reference information.

According to the method described above, pieces of information which can be used as the reference information increases, and thus, determination on each of the onboard surroundings monitoring sensors provided with the motor vehicle 2 and the onboard GPS 102 provided therewith can be more reliably performed.

### Modification Example 2

In the embodiment, abnormality determination of the onboard GPS 102 is performed in accordance with the determination condition 2, by utilizing a detection result of the roadside unit 1a and absolute location information of the motor vehicle 2, and by comparing them therebetween; however, the abnormality of the onboard GPS 102 can also be determined by another method.

For example, a case is taken into consideration in which the roadside unit 1a comprises a GPS, and in which the GPS has been verified so that it operates normally. As described above, because the motor vehicle 2 exists within a detection area of the roadside unit 1a at the timing when the determination condition 2 is verified, the roadside unit 1a and the motor vehicle 2 exist at approximately near locations with each other. For this reason, reception sensitivities of the GPSs provided with both parties are approximately coincident with each other, if they are normal. By utilizing this, when reception sensitivity of the onboard GPS 102 is at a second threshold value or lower than the second threshold value in comparison with reception sensitivity of a GPS provided with the roadside unit 1a, it is possible to determine that the onboard GPS 102 is abnormal.

Note that, as a method of determining the abnormality of the onboard GPS 102, any one of Embodiment 4 and its modification examples may be carried out; or, as the method, the abnormality determination may be more securely performed by carrying out by combining both of Embodiment 4 and each of the modification examples.

### Modification Example 3

In the embodiment, the explanation has been made, by way of example, for a case in which two roadside units are included; however, there arises a case in which three or more of roadside units are included, so that it is possible to perform the determination in accordance with a similar consideration to the abnormality determination method described in the embodiment. In such a case, pieces of information which can be used as the reference information increases, and thus, it becomes possible to perform the abnormality determination more securely.

### Modification Example 4

In the embodiment, the explanation has been made, by way of example, for a case in which one motor vehicle is included; however, there also arises a case in which two or more of motor vehicles are included, so that it is possible to perform the determination in accordance with a similar consideration to the abnormality determination method described in the embodiment. In such a case, it is so arrange that, for example as described above, each motor vehicle is identified by an image recognition camera which is provided with the roadside unit 1a, and/or that, in accordance with a method or the like in which each motor vehicle is identified on the basis of a motor vehicle operation plan, the identification is performed so that which object-matter corresponds to which motor vehicle in a detection result(s) in object-matter detection result databases of each of a roadside unit(s) and a motor vehicle(s) (or, there must be the correspondence between them, if they are mutually normal), whereby, upon the arrangement, it is possible to perform determination of abnormality on each of the onboard surroundings monitoring sensor of respective motor vehicle and on the onboard GPS 102 thereof.

The identification or verification method is not limited to the method described above, and so, various methods in which a person having ordinary skill can take into consideration may be adopted.

### Other Embodiments

Each of the embodiments described above can be freely combined, and/or an arbitrary constituent element(s) of each of the embodiments can be appropriately modified or an arbitrary constituent element(s) in each of the embodiments can be eliminated.

In addition, each of the modification examples may be individually implemented, or modification examples may be implemented by combining them each other.

Moreover, the embodiments are not necessarily limited to those embodiments disclosed as Embodiments 1 through 4, but their various modifications can be pursued on an as-needed basis.

For example, in Embodiments 1, 2 and 3 each, the abnormality determination apparatus is included on both sides of the roadside unit and the motor vehicle, or on either side of the motor vehicle and the roadside, and then, a result in which abnormality determination is performed on each device or unit basis is transmitted to the server; however, similarly to Embodiment 4, abnormality determination of all of devices or units, or part of the devices or units may be performed inside of the server. In that case, according to the manner described as in Embodiments 4, an absolute location calculation result(s) is transmitted to the server, and the server stores its reception result(s) into its database(s), so that abnormality determination of a corresponding device or unit can be performed based on the stored information. While on the other hand, without storing the reception result(s) into the server's database(s), the abnormality determination processing may be performed in a direct manner. The methods of modifications are not limited to those, and so, various methods in which a person having ordinary skill can take into consideration may be adopted.

Accordingly, the explanation has been made for the preferred embodiments and their modification examples; however, without being limited to the aforementioned embodiments and their modification examples, various modifications and replacements can be made on the aforementioned embodiments and their modification examples without departing from the scope described in the claims.

Hereinafter, various modes or aspects of the present disclosure of the application concerned are described as Supplemental Statements as those aspects are summarized below.

(Supplemental Statement 1)

An abnormality determination apparatus, comprising:
an object-matter detection unit for performing object-matter detection on the basis of a reception signal outputted from an object-matter detecting sensor;
an absolute location calculation unit for transforming a relative location of an object-matter contained in an object-matter detection result outputted from the object-matter detection unit into an absolute location; and
an abnormality determination unit for performing determination whether or not abnormality is caused in the object-matter detecting sensor by comparing absolute location information outputted from the absolute location calculation unit with reference information.

(Supplemental Statement 2)

The abnormality determination apparatus as set forth in Supplemental Statement 1, wherein the abnormality determination unit performs determination that the object-matter detecting sensor is normal, when an object-matter whose distance with respect to reference information is at a first threshold value or less is contained in the absolute location information.

(Supplemental Statement 3)

An abnormality determination system, comprising:
a roadside unit including the abnormality determination apparatus as set forth in Supplemental Statement 1, and a roadside sensor being included in the object-matter detecting sensor;
a mobile object including the abnormality determination apparatus as set forth in Supplemental Statement 1, an onboard surroundings monitoring sensor being included in the object-matter detecting sensor, and an onboard global positioning system for acquiring and transmitting current location information of the mobile object on its own; and
a server including a control device for performing notification on the basis of respective abnormality determination results outputted from the abnormality determination apparatus provided with the roadside unit and from that provided with the mobile object.

(Supplemental Statement 4)

An abnormality determination system, comprising:
a roadside unit including the abnormality determination apparatus as set forth in Supplemental Statement 2, and a roadside sensor being included in the object-matter detecting sensor;
a mobile object including the abnormality determination apparatus as set forth in Supplemental Statement 2, an onboard surroundings monitoring sensor being included in the object-matter detecting sensor, and an onboard global positioning system for acquiring and transmitting current location information of the mobile object on its own; and
a server including a control device for performing notification on the basis of respective abnormality determination results outputted from the abnormality determination apparatus provided with the roadside unit and from that provided with the mobile object.

(Supplemental Statement 5)

The abnormality determination system as set forth in Supplemental Statement 3 or Supplemental Statement 4, wherein said reference information is absolute location information of a target object being placed at a known location, and being enabled for detection by the object-matter detecting sensor.

(Supplemental Statement 6)

The abnormality determination system as set forth in Supplemental Statement 3 or Supplemental Statement 4, wherein said reference information is placement location information of the roadside unit, and the object-matter detecting sensor includes the onboard surroundings monitoring sensor.

(Supplemental Statement 7)

The abnormality determination system as set forth in Supplemental Statement 3 or Supplemental Statement 4, wherein said reference information is current location information of the mobile object, and the object-matter detecting sensor includes the roadside sensor.

(Supplemental Statement 8)

An abnormality determination system, comprising:
at least two roadside units, comprising:
   an object-matter detection device including an object-matter detection unit for performing object-matter detection on the basis of a reception signal outputted from an object-matter detecting sensor, and an absolute location calculation unit for transforming a relative location of an object-matter contained in an object-matter detection result outputted from the object-matter detection unit into an absolute location; and
   a roadside sensor being the object-matter detecting sensor, and further comprising:
a mobile object, comprising:
   an object-matter detection device;
   the object-matter detecting sensor being an onboard surroundings monitoring sensor; and
   an onboard global positioning system for acquiring and transmitting current location information of the mobile object on its own, and yet further comprising:
a server, comprising:
   an abnormality determination apparatus including an abnormal position determination unit for performing determination whether or not abnormality is caused in each of the roadside sensor, the onboard surroundings monitoring sensor and the onboard global positioning system on the basis of an object-matter detection result outputted from an object-matter detection device provided with at least one roadside unit and the mobile object and on that of placement location information of the roadside units, wherein
   the server performs notification on the basis of an abnormality determination result outputted from the abnormality determination apparatus.

(Supplemental Statement 9)

The abnormality determination system as set forth in Supplemental Statement 8, wherein the abnormal position determination unit performs determination whether or not abnormality is caused in the roadside sensors provided with the roadside units, and, when the determination is performed so that the roadside sensors are normal, performs determination whether or not abnormality is caused in the onboard surroundings monitoring sensor provided with the mobile object and the onboard global positioning system provided therewith.

(Supplemental Statement 10)

The abnormality determination system as set forth in Supplemental Statement 8 or Supplemental Statement 9, wherein the abnormal position determination unit defines placement location information of a roadside unit different from that on determination subject-matter as reference information, and performs determination whether or not abnormality is caused in a roadside sensor provided with a roadside unit on determination subject-matter by comparing the reference information with absolute location information outputted from the roadside unit on determination subject-matter.

(Supplemental Statement 11)

The abnormality determination system as set forth in any one of Supplemental Statements 8 through 10, wherein the abnormal position determination unit performs determination whether or not abnormality is caused in each of the onboard surroundings monitoring sensor provided with the mobile object and the onboard global positioning system provided therewith, when the mobile object is contained in an object-matter detection result outputted from an object-matter detection device provided with a roadside unit on determination subject-matter.

(Supplemental Statement 12)

The abnormality determination system as set forth in any one of Supplemental Statements 8 through 11, wherein the abnormal position determination unit performs determination whether or not abnormality is caused in each of the onboard surroundings monitoring sensor provided with the mobile object and the onboard global positioning system provided therewith, on the basis of results:
a first result A obtained, by defining absolute location information of a roadside unit different from that on determination subject-matter contained in an object-matter detection result outputted from an object-matter detection device provided with a roadside unit on determination subject-matter as reference information, through the comparison between the reference information and absolute location information of the roadside unit different from that on determination subject-matter contained in an object-matter detection result outputted from an object-matter detection device provided with the mobile object;
a second result B obtained, by defining absolute location information of the mobile object contained in an object-matter detection result outputted from the object-matter detection device provided with the roadside unit on determination subject-matter as reference information, through the comparison between the reference information and absolute location information of the mobile object on its own contained in an object-matter detection result outputted from the object-matter detection device provided with the mobile object; and
a third result C obtained, by defining relative location information of a roadside unit different from that on determination subject-matter and that of the mobile object contained in an object-matter detection result outputted from the object-matter detection device provided with the roadside unit on determination subject-matter as pieces of reference information, through the comparison between the pieces of reference information and relative location information of the roadside unit different from that on determination subject-matter and that of the mobile object of its own contained in an object-matter detection result outputted from the object-matter detection device provided with the mobile object.

(Supplemental Statement 13)

The abnormality determination system as set forth in any one of Supplemental Statements 8 through 12, wherein the roadside unit comprises a global positioning system; and the abnormal position determination unit defines reception sensitivity of the global positioning system provided with the roadside unit as reference information, and performs, by comparing the reference information with reception sensitivity of the onboard global positioning system provided with the mobile object, determination whether or not abnormality is caused in the onboard global positioning system provided with the mobile object.

(Supplemental Statement 14)

The abnormality determination system as set forth in any one of Supplemental Statements 8 through 13, wherein the mobile object temporarily stops at a predetermined location within a detection area of the roadside unit determined in advance, and, during a period of stoppage, an abnormality determination apparatus provided with the roadside unit and/or an object-matter detection device provided with the mobile object are operated.

(Supplemental Statement 15)

The abnormality determination system as set forth in Supplemental Statement 8 or Supplemental Statement 9, wherein the mobile object is included as at least two mobile objects.

(Supplemental Statement 16)

A method of determining abnormality, comprising:
an object-matter detection process-step of performing object-matter detection on the basis of a reception signal outputted from an object-matter detecting sensor;
an absolute location calculation process-step of transforming a relative location of an object-matter contained in an object-matter detection result obtained at the object-matter detection process-step into an absolute location; and
an abnormality determination process-step of performing determination whether or not abnormality is caused in the object-matter detecting sensor by comparing absolute location information obtained at the absolute location calculation process-step with reference information.

(Supplemental Statement 17)

The method of determining abnormality as set forth in Supplemental Statement 16, wherein the abnormality determination process-step includes a process-step of performing determination that the object-matter detecting sensor is normal, when an object-matter whose distance with respect to reference information is at a first threshold value or less is contained in the absolute location information.

(Supplemental Statement 18)

A non-transitory computer-readable recording medium storing an abnormality determination program including an instruction to execute by an abnormality determination apparatus for determining abnormality of an object-matter detecting sensor, the abnormality determination program, comprising:
an object-matter detection process-step of performing object-matter detection on the basis of a reception signal outputted from an object-matter detecting sensor;
an absolute location calculation process-step of transforming a relative location of an object-matter contained in an object-matter detection result obtained at the object-matter detection process-step into an absolute location; and
an abnormality determination process-step of performing determination whether or not abnormality is caused in the object-matter detecting sensor by comparing absolute location information obtained at the absolute location calculation process-step with reference information.

(Supplemental Statement 19)

The non-transitory computer-readable recording medium storing the abnormality determination program as set forth in Supplemental Statement 18, wherein the abnormality determination process-step includes a process-step of performing determination that the object-matter detecting sensor is normal, when an object-matter whose distance with respect to reference information is at a first threshold value or less is contained in the absolute location information.

What is claimed is:

1. An abnormality determination apparatus, comprising:
an object-matter detector for performing object-matter detection on a basis of a reception signal outputted from an object-matter detecting sensor;
an absolute location calculation device for transforming a relative location of an object-matter contained in an object-matter detection result outputted from the object-matter detector into an absolute location; and
an abnormality determination device for performing determination whether or not abnormality is caused in the object-matter detecting sensor by comparing absolute location information outputted from the absolute location calculation device with reference information.

2. The abnormality determination apparatus as set forth in claim 1, wherein the abnormality determination device performs determination that the object-matter detecting sensor is normal, when an object-matter whose distance with respect to reference information is at a first threshold value or less is contained in the absolute location information.

3. An abnormality determination system, comprising:
a roadside device including the abnormality determination apparatus as set forth in claim 1, and a roadside sensor being included in the object-matter detecting sensor;
a mobile object including the abnormality determination apparatus as set forth in claim 1, an onboard surroundings monitoring sensor being included in the object-matter detecting sensor, and an onboard global positioning system for acquiring and transmitting current location information of the mobile object on its own; and
a server including a control device for performing notification on a basis of respective abnormality determination results outputted from the abnormality determination apparatus provided with the roadside device and from that provided with the mobile object.

4. An abnormality determination system, comprising:
a roadside device including the abnormality determination apparatus as set forth in claim 2, and a roadside sensor being included in the object-matter detecting sensor;
a mobile object including the abnormality determination apparatus as set forth in claim 2, an onboard surroundings monitoring sensor being included in the object-matter detecting sensor, and an onboard global positioning system for acquiring and transmitting current location information of the mobile object on its own; and
a server including a control device for performing notification on a basis of respective abnormality determination results outputted from the abnormality determination apparatus provided with the roadside device and from that provided with the mobile object.

5. The abnormality determination system as set forth in claim 3, wherein said reference information is absolute location information of a target object being placed at a known location, and being enabled for detection by the object-matter detecting sensor.

6. The abnormality determination system as set forth in claim 3, wherein said reference information is placement location information of the roadside device, and the object-matter detecting sensor includes the onboard surroundings monitoring sensor.

7. The abnormality determination system as set forth in claim 3, wherein said reference information is current location information of the mobile object, and the object-matter detecting sensor includes the roadside sensor.

8. An abnormality determination system, comprising:
at least two roadside devices, comprising:
an object-matter detection device including an object-matter detector for performing object-matter detection on a basis of a reception signal outputted from an object-matter detecting sensor, and an absolute location calculation device for transforming a relative location of an object-matter contained in an object-matter detection result outputted from the object-matter detector into an absolute location; and
a roadside sensor being the object-matter detecting sensor, and further comprising:
a mobile object, comprising:
an object-matter detection device;
the object-matter detecting sensor being an onboard surroundings monitoring sensor; and
an onboard global positioning system for acquiring and transmitting current location information of the mobile object on its own, and yet further comprising:
a server, comprising:
an abnormality determination apparatus including an abnormal position determination device for performing determination whether or not abnormality is caused in each of the roadside sensor, the onboard surroundings monitoring sensor and the onboard global positioning system on a basis of an object-matter detection result outputted from an object-matter detection device provided with at least one roadside device and the mobile object and on that of placement location information of the roadside devices, wherein
the server performs notification on a basis of an abnormality determination result outputted from the abnormality determination apparatus.

9. The abnormality determination system as set forth in claim 8, wherein
the abnormal position determination device performs determination whether or not abnormality is caused in the roadside sensors provided with the roadside devices, and, when the determination is performed so that the roadside sensors are normal, performs determination whether or not abnormality is caused in the onboard surroundings monitoring sensor provided with the mobile object and the onboard global positioning system provided therewith.

10. The abnormality determination system as set forth in claim 8, wherein the abnormal position determination device defines placement location information of a roadside device different from that on determination subject-matter as reference information, and performs determination whether or not abnormality is caused in a roadside sensor provided with a roadside device on determination subject-matter by comparing the reference information with absolute location information outputted from the roadside device on determination subject-matter.

11. The abnormality determination system as set forth in claim 8, wherein the abnormal position determination device performs determination whether or not abnormality is caused in each of the onboard surroundings monitoring sensor provided with the mobile object and the onboard global positioning system provided therewith, when the mobile object is contained in an object-matter detection result outputted from an object-matter detection device provided with a roadside device on determination subject-matter.

12. The abnormality determination system as set forth in claim 8, wherein
the abnormal position determination device performs determination whether or not abnormality is caused in each of the onboard surroundings monitoring sensor provided with the mobile object and the onboard global positioning system provided therewith, on a basis of results:
a first result A obtained, by defining absolute location information of a roadside device different from that on determination subject-matter contained in an object-matter detection result outputted from an object-matter detection device provided with a roadside device on determination subject-matter as reference information, through a comparison between the reference information and absolute location information of the roadside device different from that on determination subject-matter contained in an object-matter detection result outputted from an object-matter detection device provided with the mobile object;
a second result B obtained, by defining absolute location information of the mobile object contained in an object-matter detection result outputted from the object-matter detection device provided with the roadside device on determination subject-matter as reference information, through a comparison between the reference information and absolute location information of the mobile object on its own contained in an object-matter detection result outputted from the object-matter detection device provided with the mobile object; and
a third result C obtained, by defining relative location information of a roadside device different from that on determination subject-matter and that of the mobile object contained in an object-matter detection result outputted from the object-matter detection device provided with the roadside device on determination subject-matter as pieces of reference information, through a comparison between the pieces of reference information and relative location information of the roadside device different from that on determination subject-matter and that of the mobile object of its own contained in an object-matter detection result outputted from the object-matter detection device provided with the mobile object.

13. The abnormality determination system as set forth in claim 8, wherein the roadside device comprises a global positioning system; and the abnormal position determination device defines reception sensitivity of the global positioning system provided with the roadside device as reference information, and performs, by comparing the reference information with reception sensitivity of the onboard global positioning system provided with the mobile object, determination whether or not abnormality is caused in the onboard global positioning system provided with the mobile object.

14. The abnormality determination system as set forth in claim 8, wherein the mobile object temporarily stops at a predetermined location within a detection area of the roadside device determined in advance, and, during a period of stoppage, an abnormality determination apparatus provided with the roadside device and/or an object-matter detection device provided with the mobile object are operated.

15. The abnormality determination system as set forth in claim 8, wherein the mobile object is included as at least two mobile objects.

16. A method of determining abnormality, comprising:
an object-matter detection process-step of performing object-matter detection on a basis of a reception signal outputted from an object-matter detecting sensor;
an absolute location calculation process-step of transforming a relative location of an object-matter contained in an object-matter detection result obtained at the object-matter detection process-step into an absolute location; and
an abnormality determination process-step of performing determination whether or not abnormality is caused in the object-matter detecting sensor by comparing absolute location information obtained at the absolute location calculation process-step with reference information.

17. The method of determining abnormality as set forth in claim 16, wherein the abnormality determination process-step includes a process-step of performing determination that the object-matter detecting sensor is normal, when an object-matter whose distance with respect to reference information is at a first threshold value or less is contained in the absolute location information.

18. A non-transitory computer-readable recording medium storing an abnormality determination program including an instruction to execute by an abnormality determination apparatus for determining abnormality of an object-matter detecting sensor, the abnormality determination program, comprising:
an object-matter detection process-step of performing object-matter detection on a basis of a reception signal outputted from an object-matter detecting sensor;
an absolute location calculation process-step of transforming a relative location of an object-matter contained in an object-matter detection result obtained at the object-matter detection process-step into an absolute location; and
an abnormality determination process-step of performing determination whether or not abnormality is caused in the object-matter detecting sensor by comparing absolute location information obtained at the absolute location calculation process-step with reference information.

19. The non-transitory computer-readable recording medium storing the abnormality determination program as set forth in claim 18, wherein the abnormality determination process-step includes a process-step of performing determination that the object-matter detecting sensor is normal, when an object-matter whose distance with respect to reference information is at a first threshold value or less is contained in the absolute location information.
